(19) United States
(12) Patent Application Publication
(10) Pub. No.: US 2025/0122842 A1
(43) Pub. Date: Apr. 17, 2025

(54) GEARBOX ASSEMBLY WITH LUBRICANT EXTRACTION VOLUME RATIO

(71) Applicants: General Electric Company, Evendale, OH (US); GE Avio S.r.l., Rivalta di Torino (IT)

(72) Inventors: Bugra H. Ertas, Niskayuna, NY (US); Xiaohua Zhang, Glenville, NY (US); Miriam Manzoni, Rivalta di Torino (IT); Flavia Turi, Bari (IT); Andrea Piazza, Torino (IT); Arthur W. Sibbach, Boxford, MA (US)

(21) Appl. No.: 18/990,617

(22) Filed: Dec. 20, 2024

Related U.S. Application Data
(63) Continuation-in-part of application No. 18/068,017, filed on Dec. 19, 2022.

(30) Foreign Application Priority Data
Jun. 22, 2022 (IT) 102022000013213

(51) Int. Cl. F02C 7/36; F02C 7/06; F02C 7/12; F16H 57/02; F16H 57/04

(52) U.S. Cl. CPC F02C 7/36; F02C 7/06; F02C 7/12; F16H 57/02; F16H 57/0423; F05D 2260/20; F05D 2260/4031; F05D 2260/98; F16H 2057/02034; F16H 2057/02039

(57) ABSTRACT

A gearbox assembly includes a gearbox and a gutter for collecting a gearbox lubricant scavenge flow from the gearbox. The gutter is characterized by a lubricant extraction volume ratio between 0.01 and 0.3, inclusive of the endpoints. The lubricant extraction volume ratio defined by: V_{G}/V_{GB}. V_{G} is a gutter volume of the gutter and V_{GB} is a gearbox volume. A gas turbine engine includes the gearbox assembly. The gas turbine engine includes an electric power system including at least one electric machine. The electric power system includes a plurality of power converters and a plurality of power distribution management units. At least two of the plurality of power converters or the plurality of power distribution management units are integrated together in a single housing.

### CROSS REFERENCE TO RELATED APPLICATIONS

The present application is a continuation-in-part application of U.S. patent application Ser. No. 18/068,017, filed Dec. 19, 2022, which claims the benefit of Italian Patent Application No. 42022000013213, filed on Jun. 22, 2022, the entire contents of which are incorporated by reference in their entireties.

### TECHNICAL FIELD

The present disclosure relates to a gearbox assembly for an engine, for example, a gas turbine engine for an aircraft.

### BACKGROUND

Lubricant is used in a power gearbox to lubricate gears and rotating parts in the gearbox. Lubricant may be supplied to lubricate the mesh between the gears. As the gears of the gearbox assembly rotate during operation, the lubricant is expelled outwardly. The lubricant is captured by a gutter.

### BRIEF DESCRIPTION OF THE DRAWINGS

Features and advantages of the present disclosure will be apparent from the following, more particular, description of various exemplary embodiments, as illustrated in the accompanying drawings, wherein like reference numbers generally indicate identical, functionally similar, or structurally similar elements.

FIG. 1 illustrates a schematic, cross-sectional view of a gas turbine engine, taken along a longitudinal centerline axis of the engine, according to an embodiment of the present disclosure.

FIG. 2 illustrates a schematic, detail view of the gearbox assembly of the engine of FIG. 1, taken at detail 2, according to an embodiment of the present disclosure.

FIG. 3 illustrates a schematic, end view of the gearbox assembly of FIG. 2, taken along line 3-3 of FIG. 1, with the fan shaft omitted for clarity, according to an embodiment of the present disclosure.

FIG. 4 shows a schematic view of a gas turbine engine, according to another embodiment.

FIG. 5A shows a schematic diagram of an electric power system for the gas turbine engine of FIG. 4, according to an embodiment of the present disclosure.

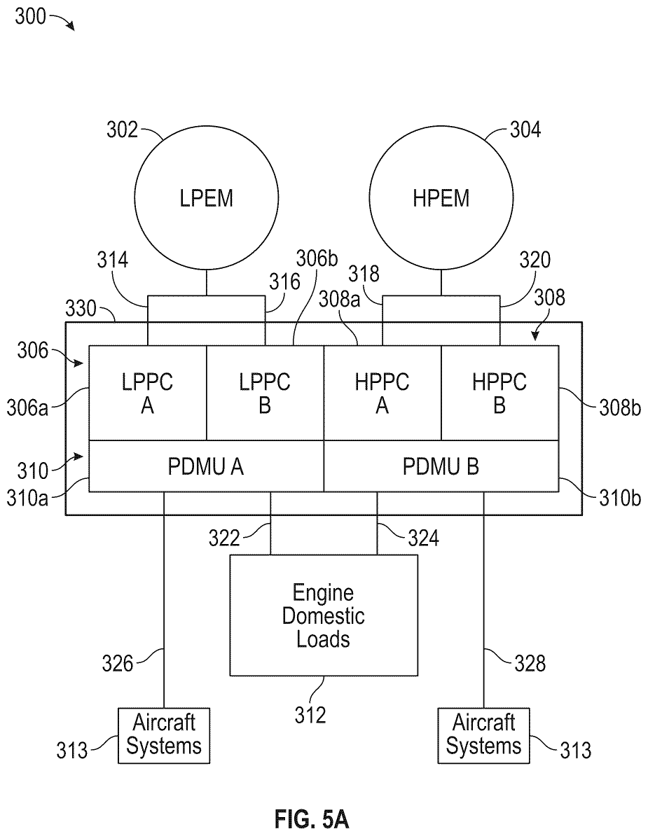

FIG. 5B shows a detailed, schematic, diagram of the electric power system of FIG. 5A.

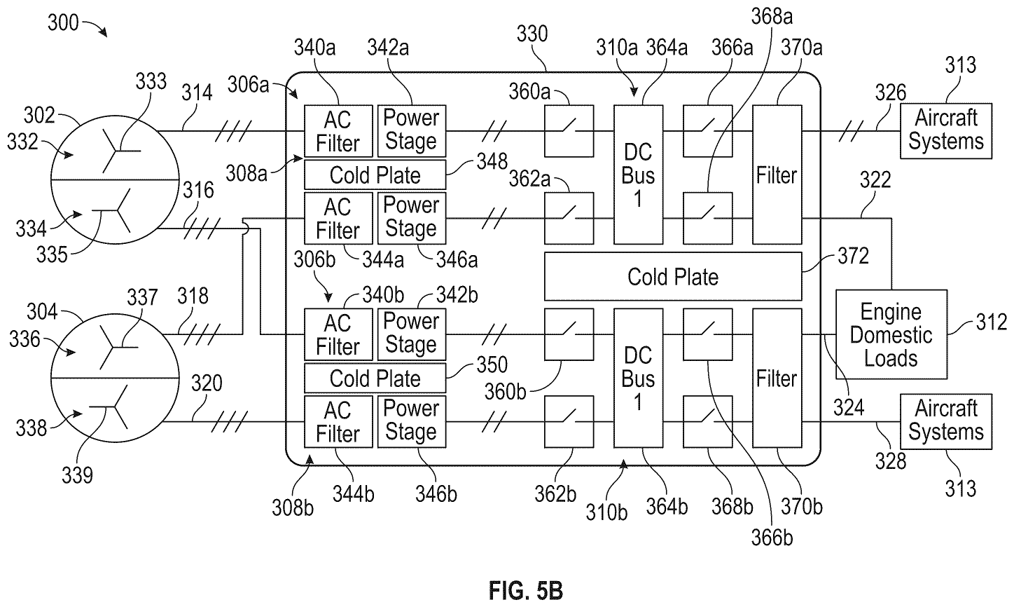

FIG. 5C shows a schematic view of the gas turbine engine of FIG. 4 having the electric power system of FIG. 5A.

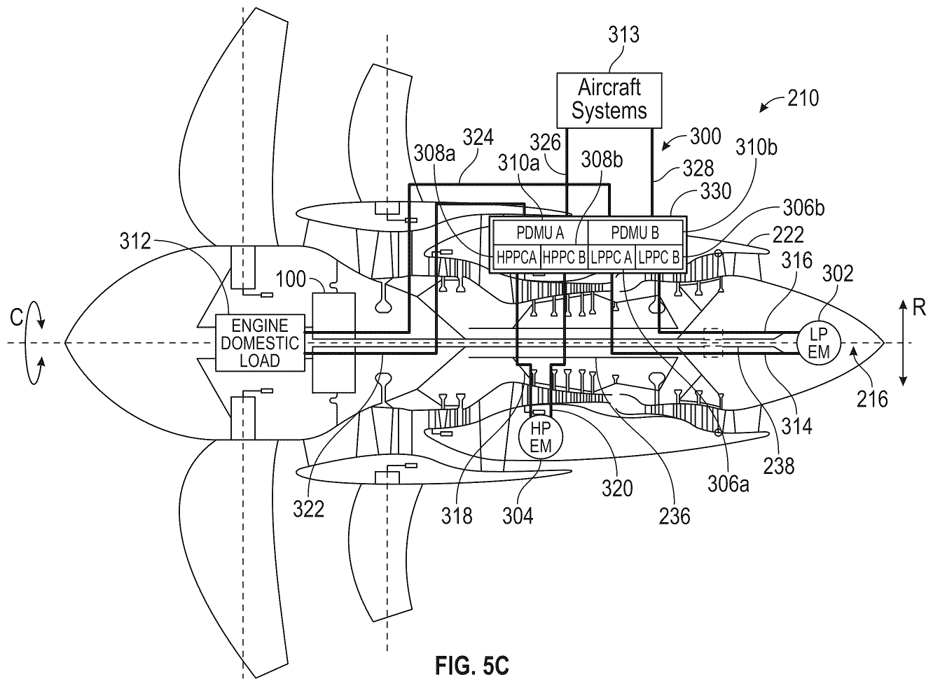

FIG. 6A shows a schematic diagram of an electric power system for the gas turbine engine of FIG. 4, according to an embodiment of the present disclosure.

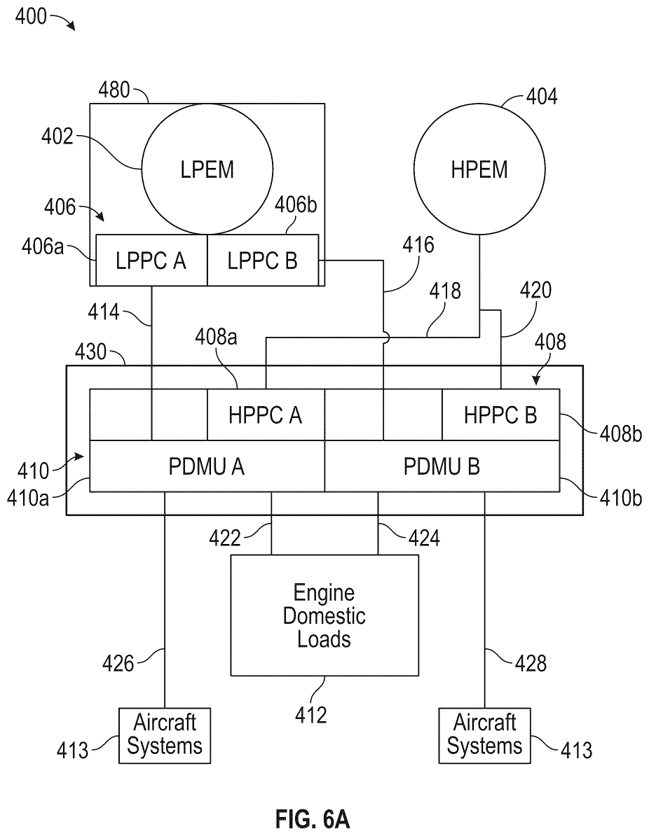

FIG. 6B shows a detailed, schematic, diagram of the electric power system of FIG. 6A.

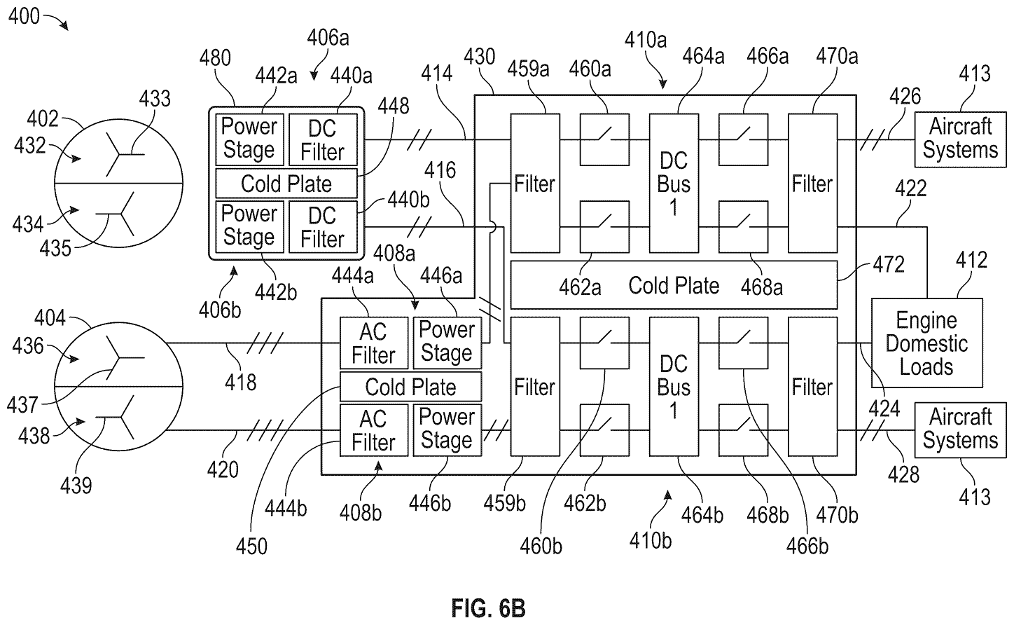

FIG. 6C shows a schematic view of the gas turbine engine of FIG. 4 having the electric power system of FIG. 6A.

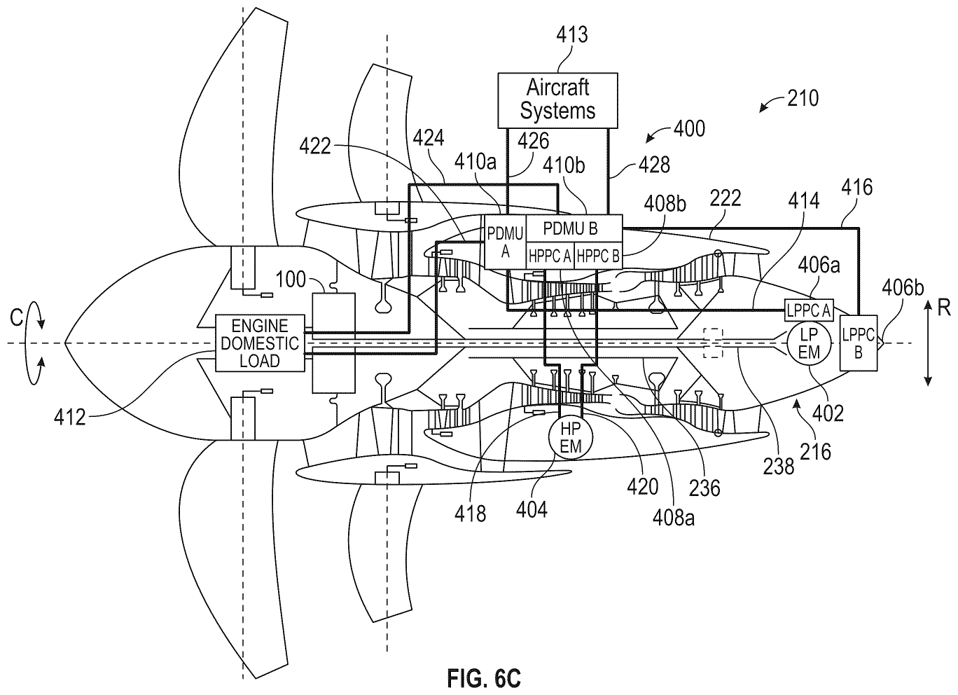

FIG. 7A shows a schematic diagram of an electric power system for the gas turbine engine of FIG. 4, according to an embodiment of the present disclosure.

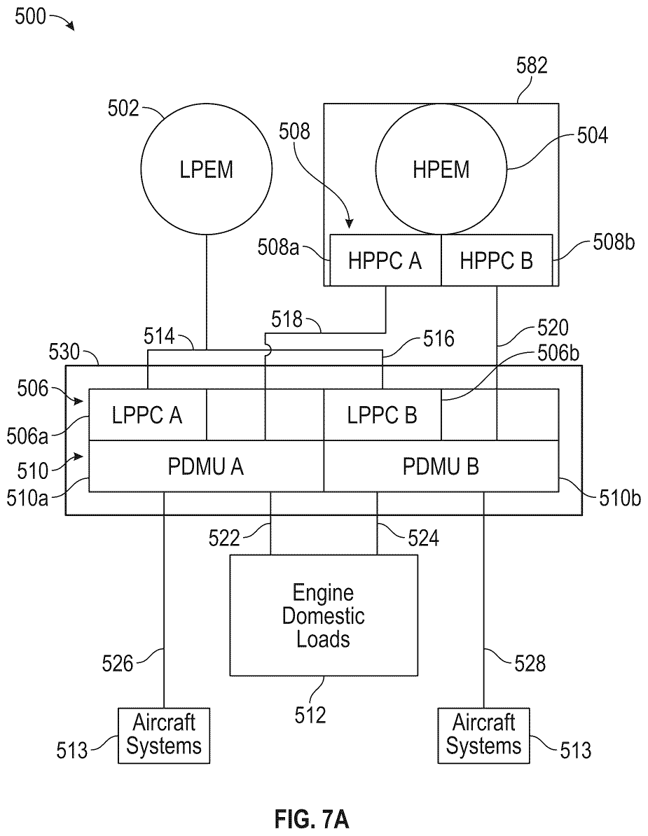

FIG. 7B shows a detailed, schematic, diagram of the electric power system of FIG. 7A.

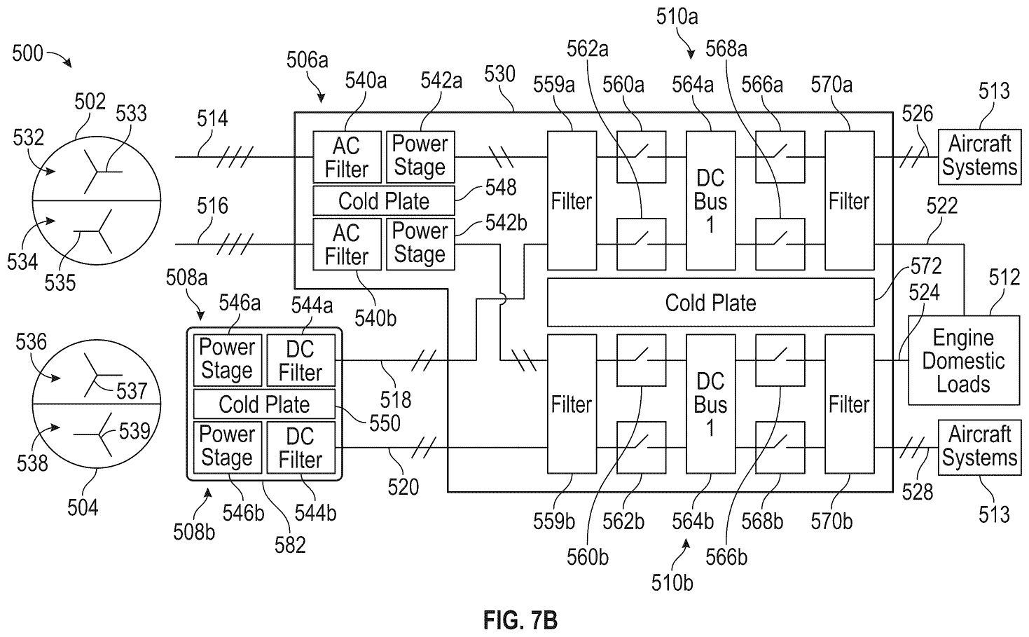

FIG. 7C shows a schematic view of the gas turbine engine of FIG. 4 having the electric power system of FIG. 7A.

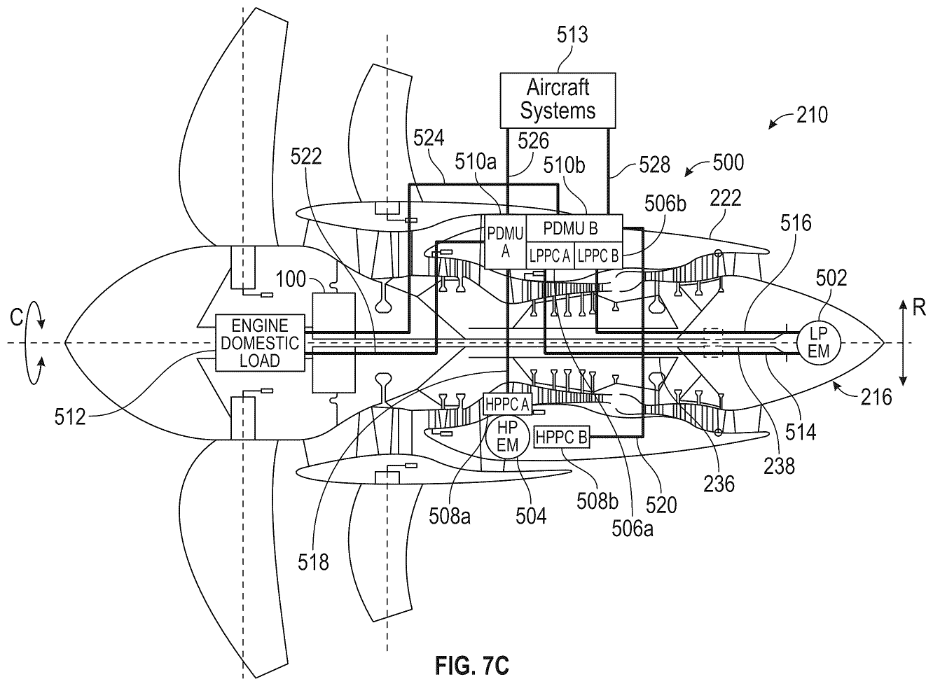

FIG. 8A shows a schematic diagram of an electric power system for the gas turbine engine of FIG. 4, according to an embodiment of the present disclosure.

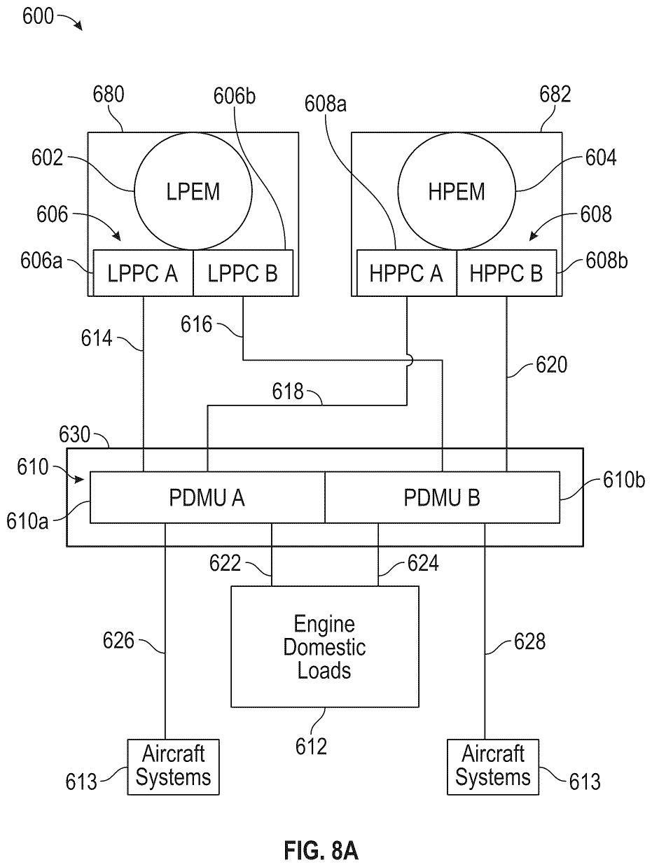

FIG. 8B shows a detailed, schematic, diagram of the electric power system of FIG. 8A.

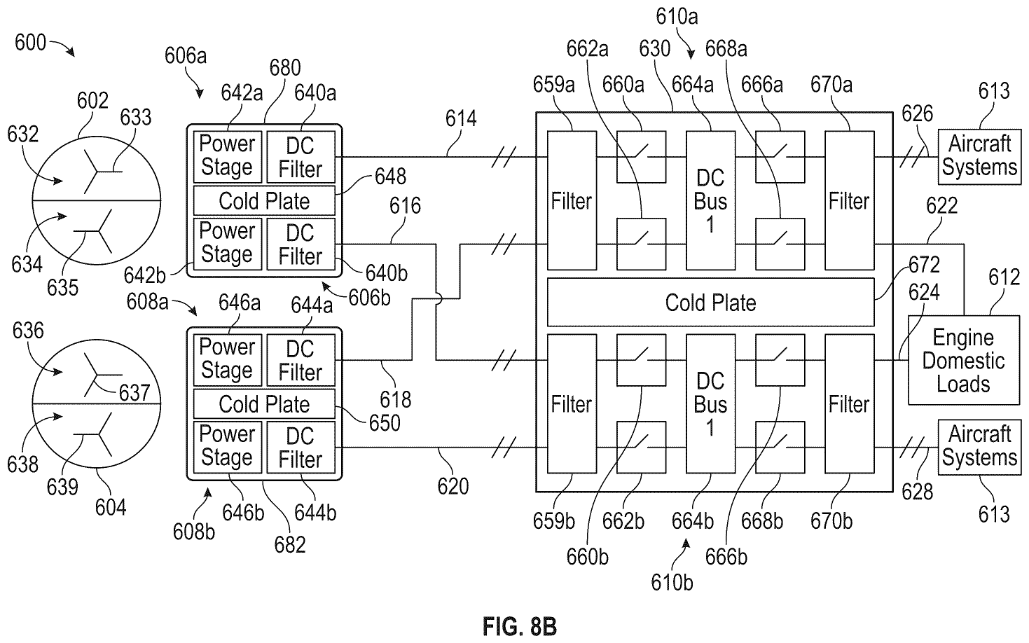

FIG. 8C shows a schematic view of the gas turbine engine of FIG. 4 having the electric power system of FIG. 8A.

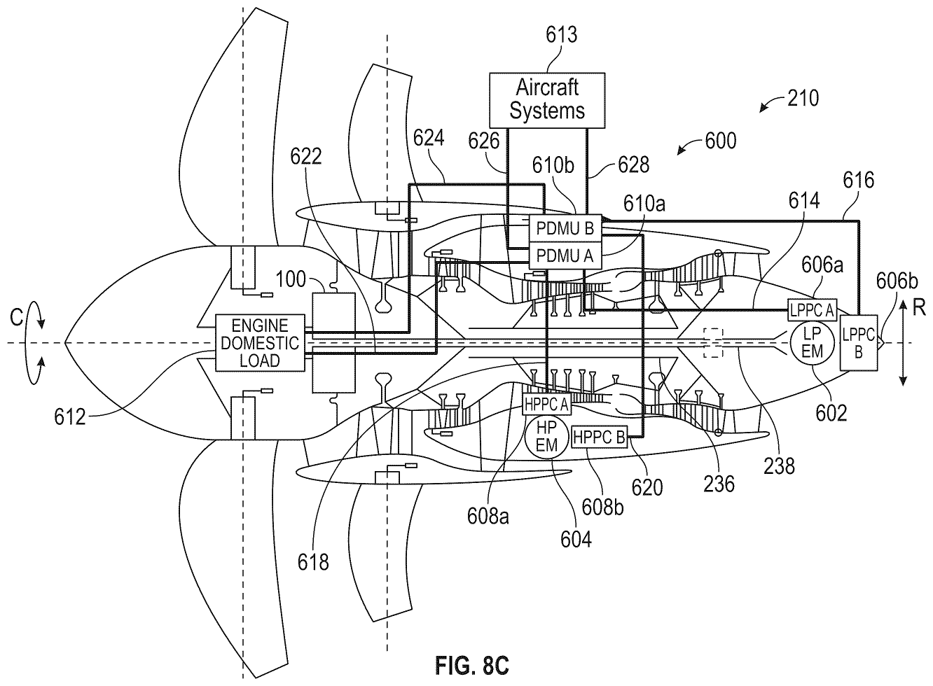

FIG. 9 illustrates a graph showing the lubricant extraction volume ratio as a function of gearbox power, according to an embodiment of the present disclosure.

FIG. 10 illustrates a graph showing the lubricant extraction volume ratio as a function of gearbox power, according to an embodiment of the present disclosure.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments are discussed in detail below. While specific embodiments are discussed, this is done for illustration purposes only. A person skilled in the relevant art will recognize that other components and configurations may be used without departing from the present disclosure.

As used herein, the terms “first,” “second,” and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. More particularly, forward and aft are used herein with reference to a direction of travel of the vehicle and a direction of propulsive thrust of the gas turbine engine.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the gas turbine engine. Moreover, the terms “radial” and “radially” refer to directions and orientations that extend substantially perpendicular to the centerline of the gas turbine engine. In addition, as used herein, the terms “circumferential” and “circumferentially” refer to directions and orientations that extend arcuately about the centerline of the gas turbine engine.

As used herein, a “low-pressure electric machine” or an “LP electric machine” is an electric machine associated (e.g., drivingly coupled) with a low-pressure (LP) shaft. In particular, an LP electric machine generates power from, or supplies power to, the LP shaft.

As used herein, a “high-pressure electric machine” or an HP electric machine is an electric machine associated (e.g., drivingly coupled) with a high-pressure (HP) shaft. In particular, an HP electric machine generates power from, or supplies power to, the HP shaft.

As used herein, a “low-pressure power converter” or an “LP power converter” is a power converter associated with the LP electric machine and converts the electrical energy from the LP electric machine from one form to another form. For example, the LP power converter can convert voltage, current, or frequency of the power from the LP electric machine.

As used herein, a “high-pressure power converter” or an “HP power converter” is a power converter associated with the HP electric machine and converts the electrical energy from the HP electric machine from one form to another form. For example, the HP power converter can convert voltage, current, or frequency of the power from the HP electric machine.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

A gas turbine engine can be configured as a geared engine. Geared engines include a power gearbox utilized to transfer power from a turbine shaft to a fan. Such gearboxes may include a sun gear, a plurality of planet gears, and a ring gear. The sun gear meshes with the plurality of planet gears and the plurality of planet gears mesh with the ring gear. In operation, the gearbox transfers the torque transmitted from a turbine shaft operating at a first speed to a fan shaft rotating at a second, lower speed. For a planet configuration of the gearbox, the sun gear may be coupled to the mid-shaft of a lower pressure turbine rotating at the first speed. The planet gears, intermeshed with the sun gear, then transfer this torque to the fan shaft through a planet carrier. In a star configuration, a ring gear is coupled to the fan shaft.

In either configuration, it is desired to increase efficiency. There are several effects that can negatively impact a gearbox's efficiency. For example, gearboxes experience windage across rotating components (e.g., in the bearing, in rolling surfaces, in the gears), that is, shear and drag forces are generated across the gears, pins, and bearings of the gearboxes. In another example, the rotating components of the gearbox experience friction losses due to the relative rotation between components. The windage and friction losses reduce the efficiency of the gearbox. In addition to reducing efficiency, windage and friction losses contribute to heat generation in gearboxes. The relative rotating surfaces and force transmission between the gears also generates heat in the gearboxes.

When a gearbox operates at higher efficiency a greater percentage of the input power from the LP shaft is transferred to the fan shaft. To improve gearbox efficiency, lubrication is provided to the gearboxes to provide a protective film at the rolling contact surfaces, to lubricate the components, and to remove heat from the gearbox. Lubrication supplied to the gearbox, however, needs to be removed from the gearbox. Buildup of lubrication in the gearbox may reduce efficiency and may not remove the heat from the gearbox. Furthermore, allowing the lubrication in the gearbox to enter other components of the engine may negatively impact operation of the other components. One way to remove lubrication from the gearbox is to scavenge the lubrication through a gutter. The gutter collects lubricant expelled from the gearbox during operation. Gutters are often designed to circumscribe the ring gear, without taking into account the requirements of the engine or the gearbox. This results in gutters that are too large or too small. A gutter that is larger than required for the engine takes up valuable space in the engine, adding weight to the engine and decreasing overall engine efficiency. A gutter that is smaller than required for the engine may not properly scavenge the lubricant from the gearbox, allowing leakage from the gutter and reducing the ability of the lubricant to remove heat from the gearbox. The inventors, seeking ways to improve upon existing gutters in terms of their size/capacity for particular architectures, gearbox types and/or mission requirements, tested different gutter configurations to ascertain what factors play into an appropriate gutter sizing.

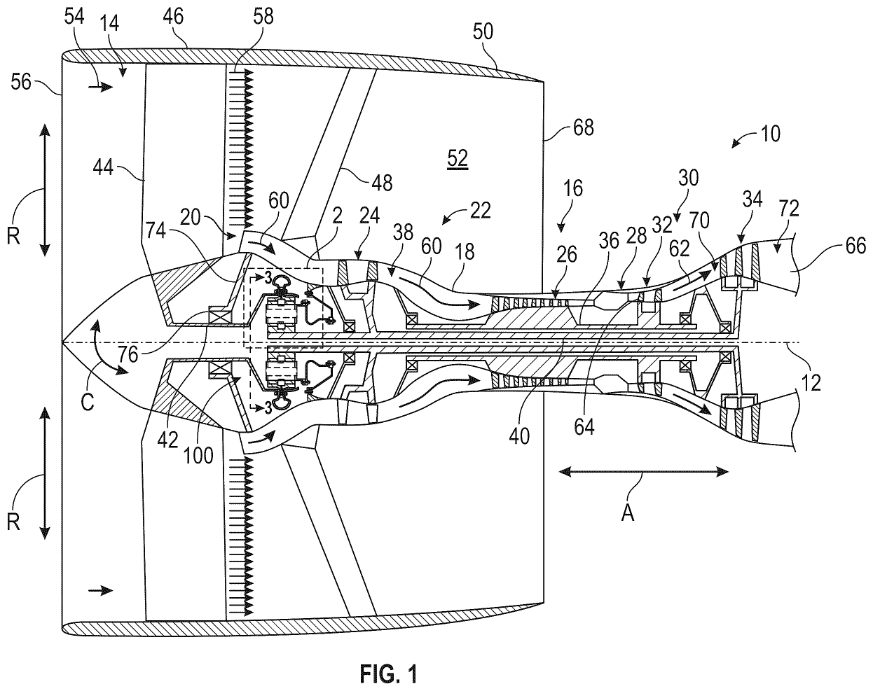

FIG. 1 illustrates a schematic, cross-sectional view of an engine, also referred to as a gas turbine engine 10. The gas turbine engine 10 defines an axial direction A extending parallel to a longitudinal, engine centerline, also referred to as a longitudinal centerline axis 12, a radial direction R that is normal to the axial direction A, and a circumferential direction C about the longitudinal centerline axis 12 (shown in/out of the page in FIG. 1). The gas turbine engine 10 includes a fan section 14 and a turbo-engine, also referred to as a core engine 16, downstream from the fan section 14.

The core engine 16 includes a core engine casing 18 that is substantially tubular and defines an annular inlet 20. The core engine casing 18 encases, in serial flow relationship, a compressor section 22 including a low-pressure compressor 24, also referred to as a booster 24, followed downstream by a high-pressure compressor 26, a combustion section 28, a turbine section 30 including a high-pressure turbine 32 followed downstream by a low-pressure turbine 34, and a jet exhaust nozzle section 72 downstream of the low-pressure turbine 34. A high-pressure shaft 36 drivingly connects the high-pressure turbine 32 to the high-pressure compressor 26 to rotate the high-pressure turbine 32 and the high-pressure compressor 26 in unison. The compressor section 22, the combustion section 28, the turbine section 30 together define a core air flowpath 38 extending from the annular inlet 20 to the jet exhaust nozzle section 72.

A low-pressure shaft 40 drivingly connects the low-pressure turbine 34 to the booster 24 to rotate the low-pressure turbine 34 and the booster 24 in unison. A gearbox assembly 100 couples the low-pressure shaft 40 to a fan shaft 42 to drive fan blades 44 of the fan section 14. The fan shaft 42 is coupled to a fan frame 74 via a bearing 76. The fan blades 44 extend radially outward from the longitudinal centerline axis 12 in the direction R. The fan blades 44 rotate about the longitudinal centerline axis 12 via the fan shaft 42 that is powered by the low-pressure shaft 40 across the gearbox assembly 100. The gearbox assembly 100 adjusts the rotational speed of the fan shaft 42 and, thus, the fan blades 44 relative to the low-pressure shaft 40. That is, the gearbox assembly 100 is a reduction gearbox and power gearbox that delivers a torque from the low-pressure shaft 40 running at a first speed, to the fan shaft 42 coupled to fan blades 44 running at a second, slower speed.

In FIG. 1, the fan section 14 includes an annular fan casing or a nacelle 46 that circumferentially surrounds the fan blades 44 and/or at least a portion of the core engine 16. The nacelle 46 is supported relative to the core engine 16 by a plurality of circumferentially spaced outlet guide vanes 48. Moreover, an aft section 50 of the nacelle 46 extends circumferentially around a portion of the outer casing of the core engine 16 to define a bypass airflow passage 52 therebetween.

During operation of the gas turbine engine 10, a volume of air, represented by airflow 54, enters the gas turbine engine 10 through an inlet 56 of the nacelle 46 and/or the fan section 14. As airflow 54 passes across the fan blades 44, a first portion of the airflow 54, represented by bypass airflow 58, is directed or is routed into the bypass airflow passage 52, and a second portion of the airflow 54, represented by core airflow 60, is directed or is routed into an upstream section of the core air flowpath 38 via the annular inlet 20. The ratio between the bypass airflow 58 and the core airflow 60 defines a bypass ratio. The pressure of the core airflow 60 is increased as the core airflow 60 is routed through the high-pressure compressor 26 and into the combustion section 28, where the now highly pressurized core airflow 60 is mixed with fuel and burned to provide combustion products or combustion gases, represented by flow 62.

The combustion gases, via flow 62, are routed into the high-pressure turbine 32 and expanded through the high-pressure turbine 32 where a portion of thermal and/or of kinetic energy from the combustion gases is extracted via sequential stages of high-pressure turbine stator vanes that are coupled to the core engine casing 18 and high-pressure turbine rotor blades 64 that are coupled to the high-pressure shaft 36, thus, causing the high-pressure shaft 36 to rotate, thereby supporting operation of the high-pressure compressor 26. The combustion gases, via flow 62, are then routed into the low-pressure turbine 34 and expanded through the low-pressure turbine 34. Here, a second portion of thermal and kinetic energy is extracted from the combustion gases via sequential stages of the low-pressure turbine stator vanes that are coupled to the core engine casing 18 and low-pressure turbine rotor blades 66 that are coupled to the low-pressure shaft 40, thus, causing the low-pressure shaft 40 to rotate. This thereby supports operation of the booster 24 and rotation of the fan blades 44 via the gearbox assembly 100.

The combustion gases, via flow 62, are subsequently routed through the jet exhaust nozzle section 72 downstream of the low-pressure turbine 34 to provide propulsive thrust. The high-pressure turbine 32, the low-pressure turbine 34, and the jet exhaust nozzle section 72 at least partially define a hot gas path 70 for routing the combustion gases, via flow 62, through the core engine 16. Simultaneously, the pressure of the bypass airflow 58 is increased as the bypass airflow 58 is routed through the bypass airflow passage 52 before being exhausted from a fan nozzle exhaust section 68 of the gas turbine engine 10, also providing propulsive thrust.

The gas turbine engine 10 depicted in FIG. 1 is by way of example only. In other exemplary embodiments, the gas turbine engine 10 may have any other suitable configuration. For example, in other exemplary embodiments, the fan section 14 may be configured in any other suitable manner (e.g., as a fixed pitch fan) and further may be supported using any other suitable fan frame configuration. Moreover, it should be appreciated that, in other exemplary embodiments, any other suitable number or configuration of compressors, turbines, shafts, or a combination thereof may be provided. In still other exemplary embodiments, aspects of the present disclosure may be incorporated into any other suitable turbine engine, such as, for example, turbofan engines, propfan engines, turbojet engines, and/or turboshaft engines.

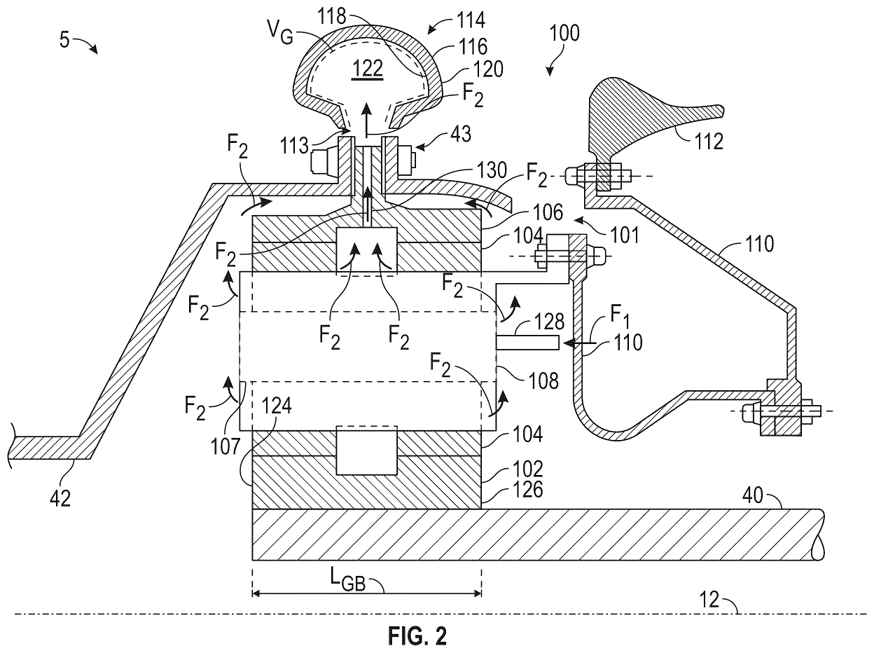

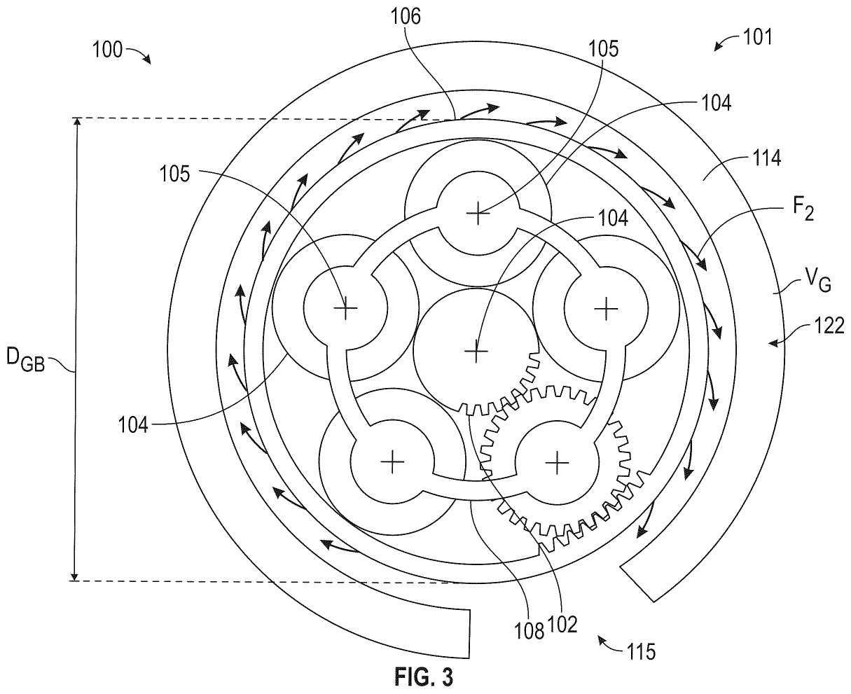

FIG. 2 illustrates a detail view 2 of FIG. 1 of the gearbox assembly 100. FIG. 3 illustrates a schematic axial end view, taken along the line 3-3 of FIG. 1, of the gears of the gearbox assembly 100. The fan shaft 42 and a coupling 43 are omitted from FIG. 3 for clarity. Referring to FIGS. 2 and 3, the gearbox assembly 100 includes a gearbox 101 and a gutter 114. The gearbox 101 includes a sun gear 102, a plurality of planet gears 104, and a ring gear 106. The low-pressure turbine 34 (FIG. 1) drives the low-pressure shaft 40, which is coupled to the sun gear 102 of the gearbox assembly 100. The gearbox assembly 100 in turn drives the fan shaft 42.

Referring to FIG. 2, the low-pressure shaft 40 causes the sun gear 102 to rotate about the longitudinal centerline axis 12. Radially outwardly of the sun gear 102, and intermeshing therewith, is the plurality of planet gears 104 that are coupled together by a planet carrier 108. The planet carrier 108 is coupled, via a flex mount 110, to an engine frame 112. The planet carrier 108 constrains the plurality of planet gears 104 while allowing each planet gear of the plurality of planet gears 104 to rotate about a respective planet gear axis 105 (FIG. 3) on a pin 107. Radially outwardly of the plurality of planet gears 104, and intermeshing therewith, is the ring gear 106, which is an annular ring gear 106. The ring gear 106 is coupled to the fan shaft 42 at a coupling 43. The ring gear 106 is coupled via the fan shaft 42 to the fan blades 44 (FIG. 1) in order to drive rotation of the fan blades 44 about the longitudinal centerline axis 12. The gutter 114 includes a gutter wall 116 having an inner surface 118 and an outer surface 120. A gutter volume V_{G} is defined within an interior 122 of the gutter wall 116. The gutter volume V_{G} is illustrated by the dashed line in FIG. 2 for illustration purposes, the volume V_{G} extends all the way to the inner surface 118 of the gutter 114. Although the gutter 114 is depicted with a relatively bell-like shape or tear-drop shape, any shape suitable to collecting lubricant is contemplated.

Although not depicted in FIG. 2, and shown only partially in FIG. 3 for clarity, each of the sun gear 102, the plurality of planet gears 104, and the ring gear 106 comprises teeth about their periphery to intermesh with teeth of the adjacent gears. The gearbox 101 has a gearbox diameter D_{GB} defined by an outer diameter of the gearbox 101. The outer diameter of the gearbox 101 may be the outer diameter of the ring gear 106 such that the gearbox diameter D_{GB} is defined by the outer diameter of the ring gear 106. Referring to FIG. 2, the sun gear 102, the plurality of planet gears 104, and the ring gear 106 are axially aligned such that a forwardmost end 124 of the gears is coplanar and an aftmost end 126 of the gears is coplanar. The gearbox 101 has an axial gearbox length L_{GB} defined from the forwardmost end 124 of the gears to the aftmost end 126 of the gears.

Referring to FIG. 3, the gutter 114 may be circular and may wholly or partially circumscribe the gears of the gearbox assembly 100. For example, the gutter 114 may wholly or partially circumscribe the ring gear 106. Therefore, the gutter 114 is located radially outward of the sun gear 102, the plurality of planet gears 104, and the ring gear 106. The gutter 114 does not rotate with the gears of the gearbox assembly 100.

The gutter 114 includes a scavenge port 115 located at or near the bottom of the gutter 114. The scavenge port 115 allows lubricant collected by the gutter 114 to be removed from the gearbox assembly 100. Although shown as a large opening in the gutter 114, the scavenge port 115 may be any size or shape aperture or port that allows a flow of fluid from the interior 122 of the gutter 114 to a passage or reservoir (not depicted) outside of the gearbox assembly 100. By locating the scavenge port 115 at or near the bottom portion of the gutter 114, gravity may assist in causing the lubricant to flow toward the scavenge port 115 and, thus, may promote removal of the lubricant from the gearbox assembly 100. Once removed from the gutter 114, the lubricant may be recirculated through a lubricant channel 128 (FIG. 2) and/or collected elsewhere for disposal and/or removal.

The gearbox assembly 100 of FIGS. 2 and 3 is a star configuration gearbox assembly, in that the planet carrier 108 is held fixed (e.g., via the flex mount 110 to the engine frame 112) and the ring gear 106 is permitted to rotate. That is, the fan section 14 is driven by the ring gear 106. However, other suitable types of gearbox assembly 100 may be employed. In one non-limiting example, the gearbox assembly 100 may be a planetary configuration, in that the planet carrier 108 is coupled to the fan shaft 42 (FIG. 1) via an output shaft to rotate the fan shaft 42, with the ring gear 106 being held stationary or fixed. In this example, the fan section 14 (FIG. 1) is driven by the planet carrier 108. In another non-limiting example, the gearbox assembly 100 may be a differential gearbox in which the ring gear 106 and the planet carrier 108 are both allowed to rotate.

During engine operation, and referring to FIGS. 2 and 3, gears of the gearbox assembly 100 rotate as previously described. A lubricant is provided to lubricate the rotating parts of the gearbox assembly 100, including the sun gear 102, the plurality of planet gears 104, the ring gear 106, and the pins 107. A lubricant system (not shown for clarity) supplies a flow F₁, also referred to as a first lubricant flow F₁, of the lubricant through the lubricant channel 128 to supply lubricant to the gearbox assembly 100. As the gears of the gearbox assembly 100 rotate, centrifugal forces expel the lubricant radially outward, away from the longitudinal centerline axis 12, as shown by flow F₂, also referred to as a second lubricant flow F₂, or a gearbox scavenge flow F₂. The flow F₂ flows around the ring gear 106 and/or through a ring gear passage 130 to be collected by the gutter 114. The lubricant flows into a gutter inlet 113. In this manner, lubricant supplied through the lubricant channel 128 is collected in the gutter 114 after flowing through and around the gears and other rotating parts of the gearbox assembly 100.

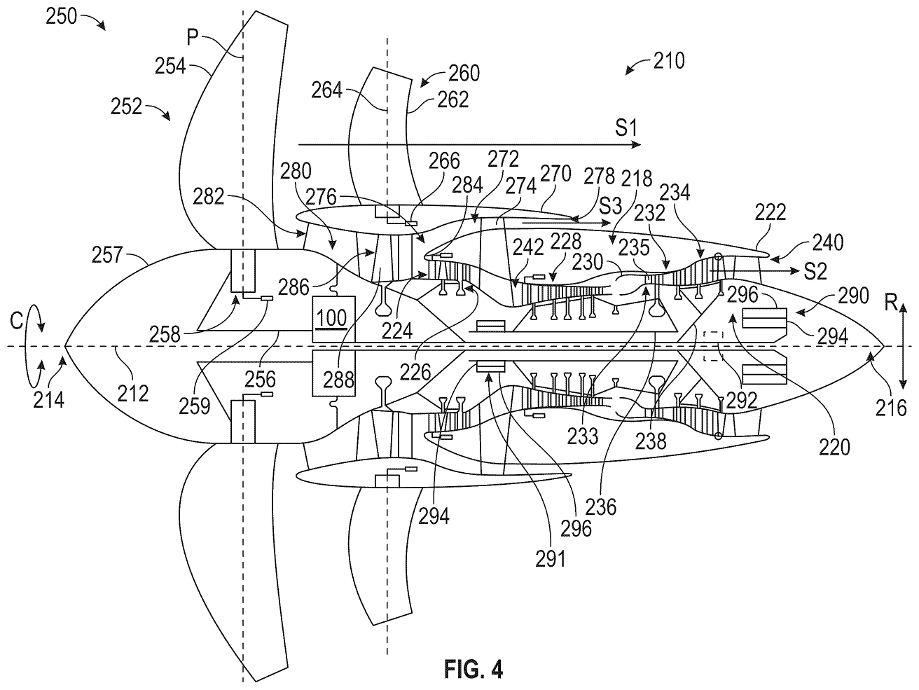

FIG. 4 shows a schematic view of a gas turbine engine 210, according to an embodiment of the present disclosure. The gas turbine engine 210 is an unducted fan engine or an open fan engine. The gas turbine engine 210 is a “three-stream engine” in that its architecture provides three distinct streams (labeled S1, S2, and S3) of thrust-producing airflow during operation, as detailed further below.

As shown in FIG. 4, the gas turbine engine 210 defines an axial direction A, a radial direction R, and a circumferential direction C. Moreover, the gas turbine engine 210 defines a longitudinal centerline axis 212 that extends along the axial direction A. In general, the axial direction A extends parallel to the longitudinal centerline axis 212, the radial direction R extends outward from, and inward to, the longitudinal centerline axis 212 in a direction orthogonal to the axial direction A, and the circumferential direction C extends three hundred sixty degrees (360°) around the longitudinal centerline axis 212. The gas turbine engine 210 extends between a forward end 214 and an aft end 216, e.g., along the axial direction A.

The gas turbine engine 210 includes a turbo-engine 220 and a fan assembly 250 positioned upstream thereof. Generally, the turbo-engine 220 includes a compressor section, a combustion section, a turbine section, and an exhaust section. As shown in FIG. 4, the turbo-engine 220 includes an engine core 218 and a casing, also referred to as a core cowl 222, that annularly surrounds the turbo-engine 220. The turbo-engine 220 and the core cowl 222 define a core inlet 224 having an annular shape that is annular about the longitudinal centerline axis 212. The turbo-engine 220 includes a low-pressure (LP) compressor 226 (also referred to as a booster) for pressurizing the air that enters the turbo-engine 220 through the core inlet 224, a high-pressure (HP) compressor 228 that receives pressurized air from the LP compressor 226 and further increases the pressure of the air, and a combustion section 230 where fuel is injected into the pressurized air and ignited to raise the temperature and the energy level of the pressurized air, generating combustion gases.

The turbo-engine 220 also includes a high-pressure (HP) turbine 232 that receives the combustion gases from the combustion section 230 and a power turbine, also referred to as a low-pressure (LP) turbine 234 that receives the combustion gases from the HP turbine 232. The HP turbine 232 drives the HP compressor 228 through a first shaft, also referred to as a high-pressure (HP) shaft 236 (also referred to as a “high-speed shaft”). In this regard, the HP turbine 232 is drivingly coupled with the HP compressor 228. The LP turbine 234 drives the LP compressor 226 and components of the fan assembly 250 through a second shaft, also referred to as a low-pressure (LP) shaft 238 (also referred to as a “low-speed shaft”). In this regard, the LP turbine 234 is drivingly coupled with the LP compressor 226 and components of the fan assembly 250. After driving each of the HP turbine 232 and the LP turbine 234, the combustion gases exit the turbo-engine 220 through a core exhaust nozzle 240. The turbo-engine 220 defines a core duct, also referred to as a core flow passage 242 that extends between the core inlet 224 and the core exhaust nozzle 240. The core flow passage 242 is an annular duct positioned generally inward of the core cowl 222 along the radial direction R.

The fan assembly 250 includes a fan 252, also referred to as a primary fan. For the embodiment of FIG. 4, the fan 252 is an open rotor fan, also referred to as an unducted fan. However, in other embodiments, the fan 252 may be ducted, e.g., by a fan casing or a nacelle circumferentially surrounding the fan 252, similar to the embodiment of FIG. 1. The fan 252 includes a plurality of fan blades 254 (only one shown in FIG. 4) that is rotatable about the longitudinal centerline axis 212 via a fan shaft 256. As shown in FIG. 4, the fan shaft 256 is coupled with the LP shaft 238 via the gearbox assembly 100, e.g., in an indirect-drive configuration. The gearbox assembly 100 is shown schematically in FIG. 4.

The fan blades 254 can be arranged in equal spacing around the longitudinal centerline axis 212. Each fan blade 254 extends outwardly from a disk 258 generally along the radial direction R. The disk 258 is covered by a fan hub 257 that is rotatable and aerodynamically contoured to promote an airflow through the plurality of fan blades 254. Each of the plurality of fan blades 254 defines a pitch axis P. For the embodiment of FIG. 4, each of the plurality of fan blades 254 of the fan 252 is rotatable about their respective pitch axis P, e.g., in unison with one another. A fan actuation system controls one or more actuators 259 to pitch the fan blades 254 about their respective pitch axis P.

The fan assembly 250 further includes a fan guide vane array 260 that includes a plurality of fan guide vanes 262 (only one shown in FIG. 4) disposed around the longitudinal centerline axis 212. For the embodiment of FIG. 4, the plurality of fan guide vanes 262 is not rotatable about the longitudinal centerline axis 212. The plurality of fan guide vanes 262 can be unshrouded as shown in FIG. 4 or can be shrouded, e.g., by an annular shroud spaced outward from the fan guide vanes 262 along the radial direction R. Each of the plurality of fan guide vanes 262 defines a vane pitch axis 264. For the embodiment of FIG. 4, each of the plurality of fan guide vanes 262 of the fan guide vane array 260 is rotatable about their respective vane pitch axis 264, e.g., in unison with one another. One or more actuators 266 are controlled to pitch the plurality of fan guide vanes 262 about their respective vane pitch axis 264. In other embodiments, each of the plurality of fan guide vanes 262 is fixed or is unable to be pitched about the vane pitch axis 264. The plurality of fan guide vanes 262 is mounted to a fan cowl 270.

The fan cowl 270 annularly encases at least a portion of the core cowl 222 and is generally positioned outward of the core cowl 222 along the radial direction R. Particularly, a downstream section of the fan cowl 270 extends over a forward portion of the core cowl 222 to define a fan duct, also referred to as a fan flow passage 272. Incoming air enters through the fan flow passage 272 through a fan flow passage inlet 276 and exits through a fan exhaust nozzle 278 to produce propulsive thrust. The fan flow passage 272 is an annular duct positioned generally outward of the core flow passage 242 along the radial direction R. The fan cowl 270 and the core cowl 222 are connected together and supported by a plurality of struts 274 (only one shown in FIG. 4) that extends substantially radially and are circumferentially spaced about the longitudinal centerline axis 212. The plurality of struts 274 is each aerodynamically contoured to direct air flowing thereby. Other struts, in addition to the plurality of struts 274, can be used to connect and to support the fan cowl 270 and the core cowl 222.

The gas turbine engine 210 also defines or includes an inlet duct 280. The inlet duct 280 extends between an engine inlet 282 and the core inlet 224 and the fan flow passage inlet 276. The engine inlet 282 is defined generally at the forward end of the fan cowl 270 and is positioned between the fan 252 and the fan guide vane array 260 along the axial direction A. The inlet duct 280 is an annular duct that is positioned inward of the fan cowl 270 along the radial direction R. Air flowing downstream along the inlet duct 280 is split, not necessarily evenly, into the core flow passage 242 and the fan flow passage 272 by a splitter 284 of the core cowl 222. The inlet duct 280 is wider than the core flow passage 242 along the radial direction R. The inlet duct 280 is also wider than the fan flow passage 272 along the radial direction R.

The fan assembly 250 also includes a mid-fan 286. The mid-fan 286 includes a plurality of mid-fan blades 288 (only one shown in FIG. 4). The plurality of mid-fan blades 288 is rotatable, e.g., about the longitudinal centerline axis 212. The mid-fan 286 is drivingly coupled with the LP turbine 234 via the LP shaft 238. The plurality of mid-fan blades 288 can be arranged in equal circumferential spacing about the longitudinal centerline axis 212. The plurality of mid-fan blades 288 is annularly surrounded (e.g., ducted) by the fan cowl 270. In this regard, the mid-fan 286 is positioned inward of the fan cowl 270 along the radial direction R. The mid-fan 286 is positioned within the inlet duct 280 upstream of both the core flow passage 242 and the fan flow passage 272. A ratio of a span of a fan blade 254 to that of a mid-fan blade 288 (a span is measured from a root to tip of the respective blade) is greater than 2 and less than 10, to achieve the desired benefits of the third stream (S3), particularly, the additional thrust it offers to the engine, which can enable a smaller diameter fan blade 254 (benefits engine installation).

Accordingly, air flowing through the inlet duct 280 flows across the plurality of mid-fan blades 288 and is accelerated downstream thereof. At least a portion of the air accelerated by the mid-fan blades 288 flows into the fan flow passage 272 and is ultimately exhausted through the fan exhaust nozzle 278 to produce propulsive thrust. Also, at least a portion of the air accelerated by the plurality of mid-fan blades 288 flows into the core flow passage 242 and is ultimately exhausted through the core exhaust nozzle 240 to produce propulsive thrust. Generally, the mid-fan 286 is a compression device positioned downstream of the engine inlet 282. The mid-fan 286 is operable to accelerate air into the fan flow passage 272, also referred to as a secondary bypass passage.

During operation of the gas turbine engine 210, an initial airflow or an incoming airflow passes through the fan blades 254 of the fan 252 and splits into a first airflow and a second airflow. The first airflow bypasses the engine inlet 282 and flows generally along the axial direction A outward of the fan cowl 270 along the radial direction R. The first airflow accelerated by the fan blades 254 passes through the fan guide vanes 262 and continues downstream thereafter to produce a primary propulsion stream or a first thrust stream S1. A majority of the net thrust produced by the gas turbine engine 210 is produced by the first thrust stream S1. The second airflow enters the inlet duct 280 through the engine inlet 282.

The second airflow flowing downstream through the inlet duct 280 flows through the plurality of mid-fan blades 288 of the mid-fan 286 and is consequently compressed. The second airflow flowing downstream of the mid-fan blades 288 is split by the splitter 284 located at the forward end of the core cowl 222. Particularly, a portion of the second airflow flowing downstream of the mid-fan 286 flows into the core flow passage 242 through the core inlet 224. The portion of the second airflow that flows into the core flow passage 242 is progressively compressed by the LP compressor 226 and the HP compressor 228 and is ultimately discharged into the combustion section 230. The discharged pressurized air stream flows downstream to the combustion section 230 where fuel is introduced to generate combustion gases or products.

The combustion section 230 defines an annular combustion chamber that is generally coaxial with the longitudinal centerline axis 212. The combustion section 230 receives pressurized air from the HP compressor 228 via a pressure compressor discharge outlet. A portion of the pressurized air flows into a mixer. Fuel is injected by a fuel nozzle (omitted for clarity) to mix with the pressurized air thereby forming a fuel-air mixture that is provided to the combustion chamber for combustion. Ignition of the fuel-air mixture is accomplished by one or more igniters (omitted for clarity), and the resulting combustion gases flow along the axial direction A toward, and into, a first stage turbine nozzle 233 of the HP turbine 232. The first stage turbine nozzle 233 is defined by an annular flow channel that includes a plurality of radially extending, circumferentially spaced nozzle vanes 235 that turn the combustion gases so that the combustion gases flow angularly and impinge upon first stage turbine blades of the HP turbine 232. The combustion gases exit the HP turbine 232 and flow through the LP turbine 234 and exit the core flow passage 242 through the core exhaust nozzle 240 to produce a core air stream, also referred to as a second thrust stream S2. As noted above, the HP turbine 232 drives the HP compressor 228 via the HP shaft 236, and the LP turbine 234 drives the LP compressor 226, the fan 252, and the mid-fan 286 via the LP shaft 238.

The other portion of the second airflow flowing downstream of the mid-fan 286 is split by the splitter 284 into the fan flow passage 272. The air enters the fan flow passage 272 through the fan flow passage inlet 276. The air flows generally along the axial direction A through the fan flow passage 272 and is ultimately exhausted from the fan flow passage 272 through the fan exhaust nozzle 278 to produce a third stream, also referred to as a third thrust stream S3.

The third thrust stream S3 is a secondary air stream that increases fluid energy to produce a minority of total propulsion system thrust. In some embodiments, a pressure ratio of the third stream is higher than that of the primary propulsion stream (e.g., a bypass or a propeller driven propulsion stream). The thrust may be produced through a dedicated nozzle or through mixing of the secondary air stream with the primary propulsion stream or a core air stream, e.g., into a common nozzle. In certain embodiments, an operating temperature of the secondary air stream is less than a maximum compressor discharge temperature for the engine. Furthermore, in certain embodiments, aspects of the third stream (e.g., airstream properties, mixing properties, or exhaust properties), and thereby a percent contribution to total thrust, are passively adjusted during engine operation or can be modified purposefully through the use of engine control features (such as fuel flow, electric machine power, variable stators, variable inlet guide vanes, valves, variable exhaust geometry, or fluidic features) to adjust or to improve overall system performance across a broad range of potential operating conditions.

The gas turbine engine 210 depicted in FIG. 4 is by way of example only. In other embodiments, the gas turbine engine 210 may have other suitable configurations. For example, the fan 252 can be ducted by a fan casing or a nacelle such that a bypass passage is defined between the fan casing and the fan cowl 270. Moreover, in other embodiments, any other suitable number or configuration of compressors, turbines, shafts, or a combination thereof may be provided. In still other embodiments, aspects of the present disclosure may be incorporated into any other suitable gas turbine engine, such as, for example, gas turbine engines defining two streams (e.g., a bypass stream and a core air stream).

Further, for the depicted embodiment of FIG. 4, the gas turbine engine 210 includes an LP electric machine 290 (e.g., a motor-generator) operably coupled with the LP shaft 238 and an HP electric machine 291 (e.g., a motor-generator) operably coupled with the HP shaft 236. In this regard, the gas turbine engine 210 is a hybrid-electric propulsion machine. As used herein, an LP electric machine is an electric machine associated (e.g., drivingly coupled) with the LP shaft 238. As used herein, an HP electric machine 291 is an electric machine associated (e.g., drivingly coupled) with the HP shaft 236. While the LP electric machine 290 and the HP electric machine 291 are described herein with respect to the gas turbine engine 210, the gas turbine engine 10 of FIG. 1 can similarly include an LP electric machine and an HP electric machine.

The LP electric machine 290 can be mechanically connected to the LP shaft 238, either directly, or indirectly, e.g., by way of a gearbox assembly 292 (shown schematically in FIG. 4). Further, although, in this embodiment the LP electric machine 290 is operatively coupled with the LP shaft 238 at an aft end of the LP shaft 238, the LP electric machine 290 can be coupled with the LP shaft 238 at any suitable location. For instance, in some embodiments, the LP electric machine 290 can be coupled with the LP shaft 238 and positioned forward of the mid-fan 286 along the axial direction A.

The HP electric machine 291 can be mechanically connected to the HP shaft 236, either directly, or indirectly, e.g., by way of a gearbox assembly (not shown in FIG. 4). Further, although, in this embodiment the HP electric machine 291 is operatively coupled with the HP shaft 236 at a forward end of the HP shaft 236, the HP electric machine 291 can be coupled with the HP shaft 236 at any suitable location. For instance, in some embodiments, the HP electric machine 291 can be coupled with the HP shaft 236 through the gearbox assembly and positioned within the core cowl 222, as detailed further below.

In some embodiments, the LP electric machine 290 can be an electric motor operable to drive or to motor the LP shaft 238 and the HP electric machine 291 can be an electric motor operable to drive or to motor the HP shaft 236. In other embodiments, the LP electric machine 290 and the HP electric machine 291 can be an electric generator operable to convert mechanical energy into electrical energy. In this way, electrical power generated by the LP electric machine 290 and the HP electric machine 291 can be directed to various engine systems or aircraft systems. In some embodiments, the LP electric machine 290 and the HP electric machine 291 can each be a motor/generator with dual functionality. The LP electric machine 290 and the HP electric machine 291 each include a rotor 294 and a stator 296. The rotor 294 of the LP electric machine 290 is coupled to the LP shaft 238 and rotates with rotation of the LP shaft 238. The rotor 294 of the HP electric machine 291 is coupled to the HP shaft 236 and rotates with rotation of the HP shaft 236. In this way, the rotor 294 rotates with respect to the stator 296, generating electrical power. Although the LP electric machine 290 and the HP electric machine 291 have been described and illustrated in FIG. 4 as having a particular configuration, the present disclosure may apply to electric machines having alternative configurations. For instance, the rotor 294 or the stator 296 may have different configurations or may be arranged in a different manner than illustrated in FIG. 4.

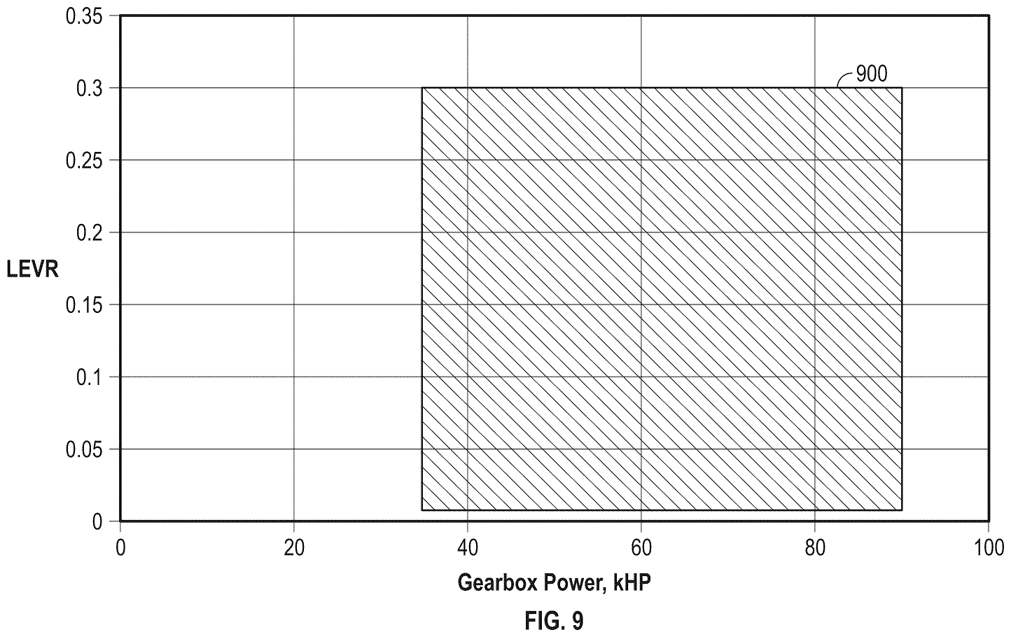

FIG. 9A shows a schematic diagram of an electric power system 300 for the gas turbine engine 210 (FIG. 4), according to an embodiment of the present disclosure. The electric power system 300 includes an LP electric machine (LPEM) 302, an HP electric machine (HPEM) 304, a plurality of LP power converters (LPPCs) 306, a plurality of HP power converters (HPPCs) 308, a plurality of power distribution management units (PDMUs) 310, and an engine domestic load 312. The LP electric machine 302 can be utilized as the LP electric machine 290 in the gas turbine engine 210 of FIG. 4. The HP electric machine 304 can be utilized as the HP electric machine 291 in the gas turbine engine 210 of FIG. 4. The plurality of PDMUs 310 includes a first PDMU (PDMU A) 310a and a second PDMU (PDMU B) 310b. The engine domestic load 312 is an electrical load that includes a device or a component that is powered by electricity. For example, the engine domestic load 312 can include an engine controller, such as a full authority digital engine control (FADEC), one or more actuators on the gas turbine engine 210, or any other devices or components of the gas turbine engine 210 that are powered by electricity.

The plurality of LP power converters 306 is electrically coupled with the LP electric machine 302 and the plurality of PDMUs 310. The plurality of LP power converters 306 includes electrical circuits that convert electrical energy between alternating current (AC) and direct current (DC). The plurality of LP power converters 306 includes a first LP power converter 306a and a second LP power converter 306b. The first LP power converter 306a is electrically coupled to the LP electric machine 302 through a first plurality of AC cables 314. The first LP power converter 306a is also electrically coupled to the first PDMU 310a. The second LP power converter 306b is electrically coupled to the LP electric machine 302 through a second plurality of AC cables 316. The second LP power converter 306b is also electrically coupled to the second PDMU 310b.

The plurality of HP power converters 308 is electrically coupled with the HP electric machine 304 and the plurality of PDMUs 310. The plurality of HP power converters 308 includes electrical circuits that convert electrical energy between alternating current (AC) and direct current (DC). The plurality of HP power converters 308 includes a first HP power converter 308a and a second HP power converter 308b. The first HP power converter 308a is electrically coupled to the HP electric machine 304 through a first plurality of AC cables 318. The first HP power converter 308a is also electrically coupled to the first PDMU 310a. The second HP power converter 308b is electrically coupled to the HP electric machine 304 through a second plurality of AC cables 320. The second HP power converter 308b is also electrically coupled to the second PDMU 310b.

The plurality of PDMUs 310 supply the electricity from the LP electric machine 302 and the HP electric machine 304 to various electric systems, as detailed further below. For example, the PDMUs 310 can supply the electricity to the engine domestic load 312 or to one or more aircraft systems 313 on an aircraft. In particular, the first PDMU 310a is electrically coupled to the engine domestic load 312 through a first plurality of DC cables 322. The second PDMU 310b is electrically coupled to the engine domestic load 312 through a second plurality of DC cables 324. In this way, the engine domestic load 312 can be powered by at least one of the LP electric machine 302 or the HP electric machine 304. The first PDMU 310a is also electrically coupled to the aircraft systems 313 through a first plurality of DC cables 326. The second PDMU 310b is electrically coupled to the aircraft systems 313 through a second plurality of DC cables 328. The one or more aircraft systems 313 can include, for example, hydraulic pumps, actuators, lighting onboard the aircraft, avionics, galleys, entertainment systems onboard the aircraft, or any other devices or components on the aircraft that are powered by electricity.

At least two of the plurality of LP power converters 306, the plurality of HP power converters 308, or the plurality of PDMUs 310 are integrated together in a single housing. In FIG. 9A, the plurality of LP power converters 306, the plurality of HP power converters 308, and the plurality of PDMUs 310 are integrated together in a PDMU housing 330. Such a configuration of combining multiple components into a single housing reduces the weight of the electric power system and reduces thermal management weight as compared to electric power systems in which the components are in separate housings. Further, combining the components into a single housing eliminates the need for additional cables (e.g., DC cables) between the plurality of LP power converters 306 and the plurality of HP power converters 308 and the plurality of PDMUs 310, further reducing the weight of the electric power system 300.

In operation, the LP electric machine 302 and the HP electric machine 304 generate electricity as a first type of current, for example, AC power, as detailed above with respect to FIG. 4. The LP electric machine 302 supplies the electricity as the AC power to the plurality of LP power converters 306 through the first plurality of AC cables 314 and the second plurality of AC cables 316. In particular, the LP electric machine 302 supplies a first portion of the AC power to the first LP power converter 306a through the first plurality of AC cables 314. The LP electric machine 302 supplies a second portion of the AC power to the second LP power converter 306b through the second plurality of AC cables 316. The HP electric machine 304 supplies the electricity as the AC power to the plurality of HP power converters 308 through the first plurality of AC cables 318 and the second plurality of AC cables 320. In particular, the HP electric machine 304 supplies a first portion of the AC power to the first HP power converter 308a through the first plurality of AC cables 318. The HP electric machine 304 supplies a second portion of the AC power to the second HP power converter 308b through the second plurality of AC cables 320.

The plurality of LP power converters 306 convert the first type of current (AC power) to a second type of current, for example, DC power, as detailed further below. The plurality of LP power converters 306 then supply the DC power to the plurality of PDMUs 310. In particular, the first LP power converter 306a supplies a first portion of the DC power to the first PDMU 310a. The second LP power converter 306b supplies a second portion of the DC power to the second PDMU 310b.

The plurality of HP power converters 308 convert the first type of current (AC power) to the second type of current (DC power), as detailed further below. The plurality of HP power converters 308 then supply the DC power to the plurality of PDMUs 310. In particular, the first HP power converter 308a supplies a first portion of the DC power to the first PDMU 310a. The second HP power converter 308b supplies a second portion of the DC power to the second PDMU 310b.

The plurality of PDMUs 310 supply the electricity as the second type of current (DC power) to at least one of the engine domestic load 312 or the one or more aircraft systems 313. In particular, the first PDMU 310a supplies the DC power to the engine domestic load 312 through the first plurality of DC cables 322. The second PDMU 310b supplies the DC power to the engine domestic load 312 through the second plurality of DC cables 324. The first PDMU 310a supplies the DC power to the one or more aircraft systems 313 through the first plurality of DC cables 326. The second PDMU 310b supplies the DC power to one or more aircraft systems 313 through the second plurality of DC cables 328. Thus, the electric power system 300 includes at least two channels to the engine domestic load 312 (e.g., the first plurality of DC cables 322 and the second plurality of DC cables 324) and at least two channels to the one or more aircraft systems 313 (e.g., the first plurality of DC cables 326 and the second plurality of DC cables 328). Such a configuration of at least two channels provides redundancy if one channel fails or becomes damaged.

FIG. 9B shows a detailed schematic diagram of the electric power system 300. As shown in FIG. 9B, the LP electric machine 302 includes a first sector 332 and a second sector 334. The first sector 332 has a first multiphase winding 333 and the second sector 334 has a second multiphase winding 335. The first multiphase winding 333 and the second multiphase winding 335 include windings or coils of the stator (e.g., the stator 296) of the LP electric machine 302 that carry the electricity generated by the LP electric machine 302. The first multiphase winding 333 is electrically coupled to the first plurality of AC cables 314 to supply the electricity (as AC power) from the LP electric machine 302 to the first LP power converter 306a. The second multiphase winding 335 is electrically coupled to the second plurality of AC cables 316 to supply the electricity from the LP electric machine 302 to the second LP power converter 306b.

The HP electric machine 304 includes a first sector 336 and a second sector 338. The first sector 336 has a first multiphase winding 337 and the second sector 338 has a second multiphase winding 339. The first multiphase winding 337 and the second multiphase winding 339 include windings or coils of the stator (e.g., the stator 296) of the HP electric machine 304 that carry the electricity generated by the HP electric machine 304. The first multiphase winding 337 is electrically coupled to the first plurality of AC cables 318 to supply the electricity (as AC power) from the HP electric machine 304 to the first HP power converter 308a. The second multiphase winding 339 is electrically coupled to the second plurality of AC cables 320 to supply the electricity from the HP electric machine 304 to the second HP power converter 308b.

The first LP power converter 306a includes a first AC filter 340a and a first power stage 342a. The second LP power converter 306b includes a second AC filter 340b and a second power stage 342b. The first AC filter 340a is electrically coupled to the LP electric machine 302 through the first plurality of AC cables 314. The second AC filter 340b is electrically coupled to the LP electric machine 302 through the second plurality of AC cables 316. The first AC filter 340a and the second AC filter 340b are electromagnetic interference (EMI) filters that suppress electromagnetic noise transmitted along the first plurality of AC cables 314 and the second plurality of AC cables 316, respectively. The first power stage 342a and the second power stage 342b convert the AC power from the LP electric machine 302 to DC power.

The first HP power converter 308a includes a first AC filter 344a and a first power stage 346a. The second HP power converter 308b includes a second AC filter 344b and a second power stage 346b. The first AC filter 344a is electrically coupled to the HP electric machine 304 through the first plurality of AC cables 318. The second AC filter 344b is electrically coupled to the HP electric machine 304 through the second plurality of AC cables 320. The first AC filter 344a and the second AC filter 344b are EMI filters that suppress electromagnetic noise transmitted along the first plurality of AC cables 318 and the second plurality of AC cables 320, respectively. The first power stage 346a and the second power stage 346b convert the AC power from the HP electric machine 304 to DC power.

In FIG. 9B, the first LP power converter 306a is thermally coupled with the first HP power converter 308a via a first power converter cold plate 348. The first power converter cold plate 348 cools the first LP power converter 306a and the first HP power converter 308a by transferring heat from the first LP power converter 306a and the first HP power converter 308a to a cooling device of a thermal management system, for example, through a liquid loop. The second LP power converter 306b is thermally coupled with the second HP power converter 308b via a second power converter cold plate 350. The second power converter cold plate 350 cools the second LP power converter 306b and the second HP power converter 308b by transferring heat from the second LP power converter 306b and the second HP power converter 308b to a cooling device, for example, through a liquid loop. The shared cold plates between the LP power converters 306 and the HP power converters 308 allows the power converters to balance peak power and reduce the requirement on the thermal management system to meet the mission profile of the electric power system 300, and, thus, reduces the size and the weight of the thermal management system as compared to thermal management systems without the benefit of the present disclosure.

The LP power converters 306 and the HP power converters 308 then supply the electricity as DC power to the PDMUs 310. The first PDMU 310a includes a first LP upstream switch 360a, a first HP upstream switch 362a, a first electrical power bus (DC Bus 1) 364a, a first LP downstream switch 366a, a first HP downstream switch 368a, and a first DC filter 370a. The second PDMU 310b includes a second LP upstream switch 360b, a second HP upstream switch 362b, a second electrical power bus (DC Bus 1) 364b, a second LP downstream switch 366b, a second HP downstream switch 368b, and a second DC filter 370b. The switches 360a, 360b, 362a, 362b, 366a, 366b, 368a, and 368b can include any type of switch for selectively opening or closing each channel, such as, for example, an insulated gate bipolar transistor, a power metal-oxide-semiconductor field-effect transistor (MOSFET), or the like.

The switches 360a, 360b, 362a, 362b, 366a, 366b, 368a, and 368b can be movable between a first position and a second position to selectively electrically connect the electric machines 302 and 304 to the engine domestic load 312 or the one or more aircraft systems 313 to supply the electricity to the engine domestic load 312 or the one or more aircraft systems 313. In some embodiments, the switches 360a, 360b, 362a, 362b, 366a, 366b, 368a, and 368b are movable between the first position and the second position depending on whether faults are detected within the electric power system 300. For example, the switches 360a, 360b, 362a, 362b, 366a, 366b, 368a, and 368b can be positioned in the first position (e.g., an open position) during normal operation of each of the channels of the electric power system 300. The switches 360a, 360b, 362a, 362b, 366a, 366b, 368a, and 368b can be positioned in the second position (e.g., a closed positioned) if there is a fault condition in one of the respective channels. The fault condition can include, for example, faults in the electric machines 302 and 304, faults in the AC cables 314, 316, 318, and 320, faults in the power converters 306 and 308, faults in the PDMUs 310, faults in the DC cables 322, 324, 326, and 328, or faults in the engine domestic load 312 or the one or more aircraft systems 313.

The electrical power busses 364a and 364b supply the electricity (as DC power) to at least one of the engine domestic load 312 or the one or more aircraft systems 313. In particular, the first electrical power bus 364a receives electricity from the LP electric machine 302 and the HP electric machine 304 and supplies the electricity to the engine domestic load 312 through the first plurality of DC cables 322 or to the one or more aircraft systems 313 through the first plurality of DC cables 326. The second electrical power bus 364b receives electricity from the LP electric machine 302 and the HP electric machine 304 and supplies the electricity to the engine domestic load 312 through the second plurality of DC cables 324 or to the one or more aircraft systems 313 through the second plurality of DC cables 328.

The first DC filter 370a and the second DC filter 370b are EMI filters that suppress electromagnetic noise transmitted along the first plurality of DC cables 322 and 326 and the second plurality of DC cables 324 and 328, respectively.

The first PDMU 310a is thermally coupled with the second PDMU 310b via a PDMU cold plate 372. The PDMU cold plate 372 cools the first PDMU 310a and the second PDMU 310b by transferring heat from the first PDMU 310a and the second PDMU 310b to a cooling device of a thermal management system, for example, through a liquid loop. The shared cold plate between first PDMU 310a and the second PDMU 310b allows the PDMUs 310 to balance peak power and reduce the requirement on the thermal management system to meet the mission profile of the electric power system 300, and, thus, reduces the size and the weight of the thermal management system as compared to thermal management systems without the benefit of the present disclosure.

FIG. 9C shows a schematic view of the gas turbine engine 210 having the electric power system 300. As shown in FIG. 9C, the LP electric machine 302 is positioned in the aft end 216 of the gas turbine engine 210. The HP electric machine 304 is positioned within the core cowl 222 in a bottom portion of the gas turbine engine 210. In such embodiments, the HP electric machine 304 can be coupled to the HP shaft 236 via a gearbox assembly. The PDMU housing 330 is positioned within the core cowl 222, for example, in a top portion of the gas turbine engine 210. In this way, the power converters 306 and 308 and the PDMUs 310 are positioned within the core cowl 222.

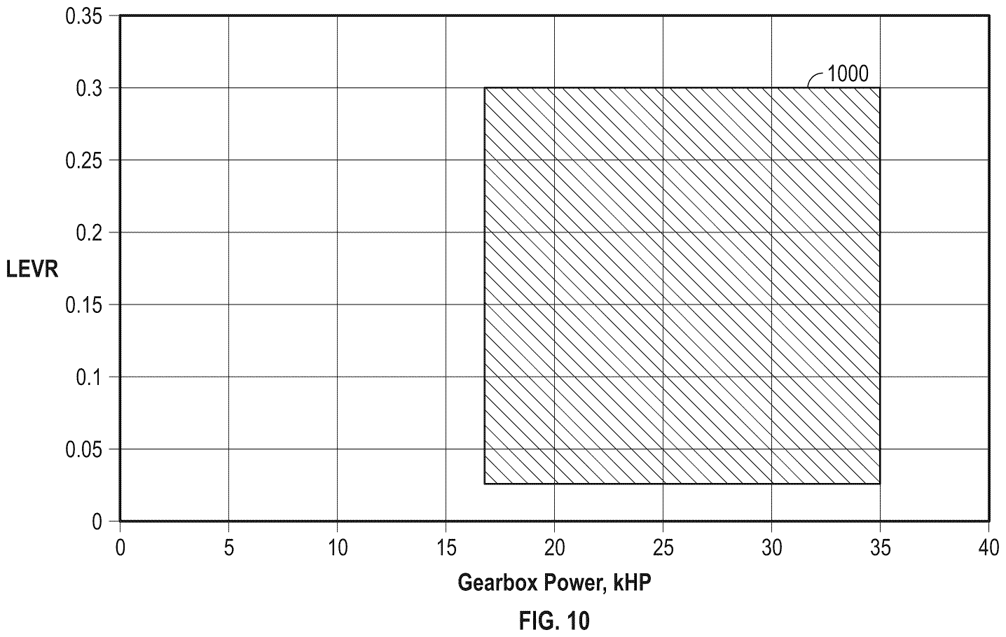

FIG. 10A shows a schematic diagram of an electric power system 400 for the gas turbine engine 210 (FIG. 4), according to an embodiment of the present disclosure. The electric power system 400 is substantially similar to the electric power system 300 of FIGS. 9A to 9C. The same or similar reference numerals will be used for components of the electric power system 400 that are the same as or similar to the components of the electric power system 300 discussed above, unless stated otherwise. The description of these components above also applies to this embodiment, and a detailed description of these components is omitted here.

The electric power system 400 includes an LP electric machine 402, an HP electric machine 404, a plurality of LP power converters 406, a plurality of HP power converters 408, a plurality of PDMUs 410, an engine domestic load 412, and one or more aircraft systems 413. The plurality of LP power converters 406 includes a first LP power converter 406a and a second LP power converter 406b. The plurality of HP power converters 408 includes a first HP power converter 408a and a second HP power converter 408b. The plurality of PDMUs 410 includes a first PDMU 410a and a second PDMU 410b.

The plurality of LP power converters 406 is electrically coupled to the plurality of PDMUs 410 through a plurality of DC cables 414 and 416. In particular, the first LP power converter 406a is electrically coupled to the first PDMU 410a through a first plurality of DC cables 414. The second LP power converter 406b is electrically coupled to the second PDMU 410b through a second plurality of DC cables 416.

The HP electric machine 404 is electrically coupled to the plurality of HP power converters 408 through a plurality of AC cables 418 and 420 including a first plurality of AC cables 418 and a second plurality of AC cables 420, similar to the embodiment of FIGS. 9A to 9C. The first PDMU 410a is electrically coupled to the engine domestic load 412 through a first plurality of DC cables 422. The second PDMU 410b is electrically coupled to the engine domestic load 412 through a second plurality of DC cables 424. The first PDMU 410a is electrically coupled to the one or more aircraft systems 413 through a first plurality of DC cables 426. The second PDMU 410b is electrically coupled to the one or more aircraft systems 413 through a second plurality of DC cables 428.

In FIG. 10A, the plurality of HP power converters 408 and the plurality of PDMUs 410 are integrated together in a PDMU housing 430. The LP power converters 406 are not integrated in the PDMU housing 430. Rather, the plurality of LP power converters 406 is integrated together with the LP electric machine 402 within a LP power converter housing 480. Such a configuration eliminates the need for AC filters in the LP power converters 406, as shown in FIG. 10B.

FIG. 10B shows a detailed schematic diagram of the electric power system 400. As shown in FIG. 10B, the LP electric machine 402 includes a first sector 432 having a first multiphase winding 433, and a second sector 434 having a second multiphase winding 435. The HP electric machine 404 includes a first sector 436 having a first multiphase winding 437, and a second sector 438 having a second multiphase winding 439.

The first LP power converter 406a includes a first DC filter 440a and a first power stage 442a. The second LP power converter 406b includes a second DC filter 440b and a second power stage 442b. In this way, the LP power converters 406 do not include AC filters as the LP power converters 406 are directly electrically coupled with the LP electric machine 402. The DC filters 440a and 440b are EMI filters the suppress electromagnetic noise transmitted along the first plurality of DC cables 414 and the second plurality of DC cables 416. The first LP power converter 406a is thermally coupled with the second LP power converter 406b via a first power converter cold plate 448.

The first HP power converter 408a includes a first AC filter 444a and a first power stage 446a. The second HP power converter 408b includes a second AC filter 444b and a second power stage 446b. The first HP power converter 408a is thermally coupled with the second HP power converter 408b via a second power converter cold plate 450.

The first PDMU 410a includes a first upstream DC filter 459a, a first LP upstream switch 460a, a first HP upstream switch 462a, a first electrical power bus 464a, a first LP downstream switch 466a, a first HP downstream switch 468a, and a first downstream DC filter 470a. The second PDMU 410b includes a second upstream DC filter 459b, a second LP upstream switch 460b, a second HP upstream switch 462b, a second electrical power bus 464b, a second LP downstream switch 466b, a second HP downstream switch 468b, and a second downstream DC filter 470b. The first PDMU 410a is thermally coupled with the second PDMU 410b via a PDMU cold plate 472.

FIG. 10C shows a schematic view of the gas turbine engine 210 having the electric power system 400. As shown in FIG. 10C, the LP electric machine 402, the first LP power converter 406a, and the second LP power converter 406b are positioned in the aft end 216 of the gas turbine engine 210. The HP electric machine 404 is positioned within the core cowl 222 in a bottom portion of the gas turbine engine 210. In such embodiments, the HP electric machine 404 can be coupled to the HP shaft 236 via a gearbox assembly. The first HP power converter 308a, the second HP power converter 308b, and the PDMUs 310a and 310b are positioned within the core cowl 222 in a top portion of the gas turbine engine 210.

FIG. 11A shows a schematic diagram of an electric power system 500 for the gas turbine engine 210 (FIG. 4), according to an embodiment of the present disclosure. The electric power system 500 is substantially similar to the electric power system 300 of FIGS. 9A to 9C. The same or similar reference numerals will be used for components of the electric power system 500 that are the same as or similar to the components of the electric power system 300 discussed above, unless stated otherwise. The description of these components above also applies to this embodiment, and a detailed description of these components is omitted here.

The electric power system 500 includes an LP electric machine 502, an HP electric machine 504, a plurality of LP power converters 506, a plurality of HP power converters 508, a plurality of PDMUs 510, an engine domestic load 512, and one or more aircraft systems 513. The plurality of LP power converters 506 includes a first LP power converter 506a and a second LP power converter 506b. The plurality of HP power converters 508 includes a first HP power converter 508a and a second HP power converter 508b. The plurality of PDMUs 510 includes a first PDMU 510a and a second PDMU 510b.

The LP electric machine 502 is electrically coupled to the plurality of LP power converters 506 through a plurality of AC cables 514 and 516 including a first plurality of AC cables 514 and a second plurality of AC cables 516, similar to the embodiment of FIGS. 9A to 9C. The plurality of HP power converters 508 is electrically coupled to the plurality of PDMUs 510 through a plurality of DC cables 518 and 520. In particular, the first HP power converter 508a is electrically coupled to the first PDMU 510a through a first plurality of DC cables 518. The second HP power converter 508b is electrically coupled to the second PDMU 510b through a second plurality of DC cables 520.

The first PDMU 510a is electrically coupled to the engine domestic load 512 through a first plurality of DC cables 522. The second PDMU 510b is electrically coupled to the engine domestic load 512 through a second plurality of DC cables 524. The first PDMU 510a is electrically coupled to the one or more aircraft systems 513 through a first plurality of DC cables 526. The second PDMU 510b is electrically coupled to the one or more aircraft systems 513 through a second plurality of DC cables 528.

In FIG. 11A, the plurality of LP power converters 506 and the plurality of PDMUs 510 are integrated together in a PDMU housing 530. The HP power converters 508 are not integrated in the PDMU housing 530. Rather, the plurality of HP power converters 508 is integrated together with the HP electric machine 504 within an HP power converter housing 582. Such a configuration eliminates the need for AC filters in the HP power converters 508, as shown in FIG. 11B.

FIG. 11B shows a detailed schematic diagram of the electric power system 500. As shown in FIG. 11B, the LP electric machine 502 includes a first sector 532 having a first multiphase winding 533, and a second sector 534 having a second multiphase winding 535. The HP electric machine 504 includes a first sector 536 having a first multiphase winding 537, and a second sector 538 having a second multiphase winding 539.

The first LP power converter 506a includes a first AC filter 540a and a first power stage 542a. The second LP power converter 506b includes a second AC filter 540b and a second power stage 542b. The first LP power converter 506a is thermally coupled with the second LP power converter 506b via a first power converter cold plate 548.

The first HP power converter 508a includes a first DC filter 544a and a first power stage 546a. The second HP power converter 508b includes a second DC filter 544b and a second power stage 546b. In this way, the HP power converters 508 do not include AC filters as the HP power converters 508 are directly electrically coupled with the HP electric machine 504. The DC filters 544a and 544b are EMI filters the suppress electromagnetic noise transmitted along the first plurality of DC cables 518 and the second plurality of DC cables 520. The first HP power converter 508a is thermally coupled with the second HP power converter 508b via a second power converter cold plate 550.

The first PDMU 510a includes a first upstream DC filter 559a, a first LP upstream switch 560a, a first HP upstream switch 562a, a first electrical power bus 564a, a first LP downstream switch 566a, a first HP downstream switch 568a, and a first downstream DC filter 570a. The second PDMU 510b includes a second upstream DC filter 559b, a second LP upstream switch 560b, a second HP upstream switch 562b, a second electrical power bus 564b, a second LP downstream switch 566b, a second HP downstream switch 568b, and a second downstream DC filter 570b. The first PDMU 510a is thermally coupled with the second PDMU 510b via a PDMU cold plate 572.

FIG. 11C shows a schematic view of the gas turbine engine 210 having the electric power system 500. As shown in FIG. 11C, the LP electric machine 502 is positioned in the aft end 216 of the gas turbine engine 210. The HP electric machine 504, the first HP power converter 508a, and the second HP power converter 508b are positioned within the core cowl 222 in a bottom portion of the gas turbine engine 210. In such embodiments, the HP electric machine 504 can be coupled to the HP shaft 236 via a gearbox assembly. The first LP power converter 506a, the second LP power converter 506b, and the PDMUs 510a and 510b are positioned within the core cowl 222 in a top portion of the gas turbine engine 210.

FIG. 12A shows a schematic diagram of an electric power system 600 for the gas turbine engine 210 (FIG. 4), according to an embodiment of the present disclosure. The electric power system 600 is substantially similar to the electric power system 300 of FIGS. 9A to 9C. The same or similar reference numerals will be used for components of the electric power system 600 that are the same as or similar to the components of the electric power system 300 discussed above, unless stated otherwise. The description of these components above also applies to this embodiment, and a detailed description of these components is omitted here.

The electric power system 600 includes an LP electric machine 602, an HP electric machine 604, a plurality of LP power converters 606, a plurality of HP power converters 608, a plurality of PDMUs 610, an engine domestic load 612, and one or more aircraft systems 613. The plurality of LP power converters 606 includes a first LP power converter 606a and a second LP power converter 606b. The plurality of HP power converters 608 includes a first HP power converter 608a and a second HP power converter 608b. The plurality of PDMUs 610 includes a first PDMU 610a and a second PDMU 610b.

The plurality of LP power converters 606 is electrically coupled to the plurality of PDMUs 610 through a plurality of DC cables 614 and 616. In particular, the first LP power converter 606a is electrically coupled to the first PDMU 610a through a first plurality of DC cables 614. The second LP power converter 606b is electrically coupled to the second PDMU 610b through a second plurality of DC cables 616. The plurality of HP power converters 608 is electrically coupled to the plurality of PDMUs 610 through a plurality of DC cables 618 and 620. In particular, the first HP power converter 608a is electrically coupled to the first PDMU 610a through a first plurality of DC cables 618. The second HP power converter 608b is electrically coupled to the second PDMU 610b through a second plurality of DC cables 620.

The first PDMU 610a is electrically coupled to the engine domestic load 612 through a first plurality of DC cables 622. The second PDMU 610b is electrically coupled to the engine domestic load 612 through a second plurality of DC cables 624. The first PDMU 610a is electrically coupled to the one or more aircraft systems 613 through a first plurality of DC cables 626. The second PDMU 610b is electrically coupled to the one or more aircraft systems 613 through a second plurality of DC cables 628.

In FIG. 12A, the PDMUs 610 are integrated together in a PDMU housing 630. The LP power converters 606 and the HP power converters 608 are not integrated in the PDMU housing 630. Rather, the plurality of LP power converters 606 is integrated together with the LP electric machine 602 within an LP power converter housing 680. Such a configuration eliminates the need for AC filters in the LP power converters 606, as shown in FIG. 12B. Similarly, the plurality of HP power converters 608 is integrated together with the HP electric machine 604 within an HP power converter housing 682. Such a configuration eliminates the need for AC filters in the HP power converters 608, as shown in FIG. 12B.

FIG. 12B shows a detailed schematic diagram of the electric power system 600. As shown in FIG. 12B, the LP electric machine 602 includes a first sector 632 having a first multiphase winding 633, and a second sector 634 having a second multiphase winding 635. The HP electric machine 604 includes a first sector 636 having a first multiphase winding 637, and a second sector 638 having a second multiphase winding 639.

The first LP power converter 606a includes a first DC filter 640a and a first power stage 642a. The second LP power converter 606b includes a second DC filter 640b and a second power stage 642b. In this way, the LP power converters 606 do not include AC filters as the LP power converters 606 are directly electrically coupled with the LP electric machine 602. The first LP power converter 606a is thermally coupled with the second LP power converter 606b via a first power converter cold plate 648.

The first HP power converter 608a includes a first DC filter 644a and a first power stage 646a. The second HP power converter 608b includes a second DC filter 644b and a second power stage 646b. In this way, the HP power converters 608 do not include AC filters as the HP power converters 608 are directly electrically coupled with the HP electric machine 604. The first HP power converter 608a is thermally coupled with the second HP power converter 608b via a second power converter cold plate 650.

The first PDMU 610a includes a first upstream DC filter 659a, a first LP upstream switch 660a, a first HP upstream switch 662a, a first electrical power bus 664a, a first LP downstream switch 666a, a first HP downstream switch 668a, and a first downstream DC filter 670a. The second PDMU 610b includes a second upstream DC filter 659b, a second LP upstream switch 660b, a second HP upstream switch 662b, a second electrical power bus 664b, a second LP downstream switch 666b, a second HP downstream switch 668b, and a second downstream DC filter 670b. The first PDMU 610a is thermally coupled with the second PDMU 610b via a PDMU cold plate 672.

FIG. 12C shows a schematic view of the gas turbine engine 210 having the electric power system 600. As shown in FIG. 12C, the LP electric machine 602, the first LP power converter 606a, and the second LP power converter 606b are positioned in the aft end 216 of the gas turbine engine 210. The HP electric machine 604, the first HP power converter 608a, and the second HP power converter 608b are positioned within the core cowl 222 in a bottom portion of the gas turbine engine 210. In such embodiments, the HP electric machine 604 can be coupled to the HP shaft 236 via a gearbox assembly. The PDMUs 310a and 310b are positioned within the core cowl 222 in a top portion of the gas turbine engine 210.

Accordingly, the configurations of the electric power systems 300, 400, 500, and 600 of combining multiple components into a single housing reduces the weight of the electric power system and reduces thermal management weight as compared to electric power systems in which the components are in separate housings, while achieving a substantially same power density of and power conversion efficiency. By combining multiple components into a single housing, the filter circuitry and other circuitry for the interface between components can be eliminated, providing a further weight reduction. Further, a single mounting system can be used to mount the electric power system to the gas turbine engine, rather than a separate mounting system for each component of the electric power system, thus, further reducing the weight of the electric power system as compared to electric power systems without the benefit of the present disclosure. The vibration response of the single mounting system is similar to the vibration response of each individual mounting system such that vibrations are damped to minimize high cycle fatigue and low cycle fatigue of the overall mounting assembly.

With reference back to FIG. 3, as the volume of the gearbox 101 increases, the diameter of the gearbox D_{GB}, increases. As the power output of the gearbox 101 increases the amount of heat generated increases. The increase in heat generation increases the volume of lubricant required to operate the gearbox, which calls for an increased gutter volume V_{G} for capture and recirculation of lubricant through the scavenging system. However, it is also desired to reduce the overall footprint of the gearbox, oil and scavenge system given an emphasis on decreasing packaging space available for the gearbox and oil scavenge system, especially for engines with power gearboxes operating with relatively high gear ratios, e.g., between, inclusive of the endpoints, 2.5 to 3.5, 3.0, 3.25, 4.0, and above gear ratios (GRs).

In view of the foregoing, it is desirable to improve, or at least maintain, a target efficiency of a gearbox without oversizing a gutter or scavenge system, or while reducing its size to accommodate only what is needed or can be accommodated in terms of weight increase or volume. When developing a gas turbine engine, the interplay among components can make it particularly difficult to select or to develop one component (e.g., the gutter 114) during engine design and prototype testing, especially, when some components are at different stages of completion. For example, one or more components may be nearly complete, yet one or more other components may be in an initial or preliminary phase. It is desired to arrive at what is possible at an early stage of design, so that the down selection of candidate optimal designs, given the tradeoffs, become more possible. Heretofore, the process has sometimes been more ad hoc, selecting one design or another without knowing the impact when a concept is first taken into consideration. For example, various aspects of the fan section 14 design, compressor section 22 design, combustion section 28, and/or turbine section 30 design, may not be known at the time of design of the gutter, but such components impact the size of the gearbox 101 required and the amount of lubricant required, and thus, the design of the gutter 114.

The inventors desire to arrive at a more favorable balance between maximizing gearbox scavenge flow collection while minimizing other, potential negative effects on an improperly chosen gutter size had previously involved, e.g., the undertaking of multivariate trade studies, which may or may not have yielded an improved, or best match gutter/scavenge for a particular architecture. Unexpectedly, it was discovered that a relationship exists between the volume of the gutter and gearbox volume that uniquely identified a finite and readily ascertainable (in view of this disclosure) number of embodiments suited for a particular architecture, which improves the weight—volume—scavenge effectiveness tradeoffs for a particular architecture. This relationship the inventors refer to as the Lubricant Extraction Volume Ratio (LEVR):

$$LEVR = \frac{{V}_{G}}{{V}_{GB}} \qquad ( 1 )$$

V_{G} represents the gutter volume, as identified with respect to FIGS. 2 and 3. The gutter volume may be determined by calculating the volume within a cross section of the gutter. V_{GB} represents the gearbox volume, which is defined below (2). For engine power between eighteen kHP and thirty-five kHP, inclusive of the endpoints, the gearbox volume V_{GB} is between eight hundred in³ and two thousand in³, inclusive of the endpoints. In some examples, the engine is a turbofan engine. The inventors found that the gutter volume V_{G} should be selected based on the range 0.01≤LEVR≤ to 0.3 (gutter volume is between 1 percent and 30 percent the gearbox volume, inclusive of the endpoints).

$${V}_{GB} = {L}_{GB} * π * {( \frac{{D}_{GB}}{2} )}^{2} \qquad ( 2 )$$

L_{GB} represents the gearbox length, as identified with respect to FIG. 2. Although described with respect to gears of the same length in FIG. 2, the gearbox length may be defined by any of the sun gear 102, a planet gear 104, or the ring gear 106, instances when the aforementioned gears are of different lengths. In (2), D_{GB} represents the gearbox diameter, as identified with respect to FIG. 3.

In some embodiments, and as shown in a region 900 of FIG. 9, LEVR is between 0.01 and 0.3, inclusive of the endpoints, for maximum gearbox power of between thirty-five kHP and ninety kHP, inclusive of the endpoints. In some embodiments, and as shown in a region 1000 of FIG. 10, LEVR is between 0.03 and 0.3, inclusive of the endpoints, for a maximum gearbox power of less than or equal to thirty-five kHP.

If the gutter volume relative to the gearbox volume is such that the LEVR upper limit is exceeded (e.g., a “large gutter”), there is too large of a volume within the gutter than is needed to recover gearbox lubricant scavenge, which can lead to increased lubricant churning loss and lubricant foaming in the gutter, leading to increased power loss in the overall gearbox assembly. The foaming in the gutter can generate drag in the gutter and negatively impact gearbox performance, and ultimately, engine performance. Furthermore, a large gutter requires more radial space and the increased material, mass, and size, etc., of the large gutter encroaches upon other system components within the engine (e.g., the core flow path), which, again, negatively impacts gearbox performance. The LEVR is selected to balance recovery of gearbox lubricant scavenge and impact to the engine operation and efficiency.

If the gutter volume relative to the gearbox volume is such that the LEVR lower limit is violated (e.g., a “small gutter”), there is too small of a volume within the gutter than is needed to recover the gearbox lubricant scavenge. The gutter will not fully capture the gearbox lubricant scavenge (e.g., flow F₂), leading to inadequate removal of the lubricant from the gearbox sump. This can lead to leakage of the scavenge lubricant back into the gearbox and/or to other areas of the engine, negatively impacting the performance of both the gearbox and the engine. The lower limit of the LEVR is selected to balance recovery of gearbox lubricant scavenge and impact to the gearbox and engine operation and efficiency (e.g., volume & weight penalty).

Taking into consideration the above considerations for selecting upper and lower limits, the LEVR may also be defined in terms of a Power Factor, Flow Transition Time and a Heat Density Parameter:

$$LEVR = PF * \frac{FT}{HDP} \qquad ( 3 )$$

where PF represents the Power Factor, FT represents the Flow Transition Time, and HDP represents the Heat Density parameter. The Power Factor PF is defined in (4):

$$PF = PD * ( 1 - η ) \qquad ( 4 )$$

where PD represents the gearbox power density and η represents the gearbox efficiency. The power density PD is a ratio of the power of the gearbox to the volume of the gearbox and is between fifteen thousand hp/ft³ and forty-five thousand hp/ft³, inclusive of the endpoints. The gearbox efficiency is between 99.2 percent and 99.8 percent, inclusive of the endpoints.

The Flow Transition Time FT is given by:

$$FT = \frac{{V}_{G}}{{V}_{dot}} \qquad ( 5 )$$

where V_{G} represents the gutter volume, as identified with respect to FIGS. 2 and 3. V_{dot} represents the lubricant volumetric flow rate. The lubricant volumetric flow rate is defined by the gearbox power and the efficiency. Since the inefficiency of the gearbox generates heat, a certain quantity of lubricant is required to remove the heat. The Flow Transition Time is the time it takes the lubricant to traverse the entire gutter volume. The Flow Transition Time indirectly links the gutter volume to the gearbox volume. The Flow Transition Time is between 1.5 and eleven seconds, inclusive of the endpoints.

The Heat Density parameter HDP is defined as:

$$HDP = ρ * C * Δ T \qquad ( 6 )$$

where ρ represents the fluid density, C represents the lubricant specific heat, and ΔT represents the temperature rise in the lubricant, which, is between twenty degrees Celsius and forty-five degrees Celsius, inclusive of the endpoints.

Table 1 describes exemplary embodiments 1 and 2 identifying the LEVR for various engines. The embodiments 1 and 2 are for narrow body, turbofan engines. The LEVR of the present disclosure is not limited to such engines, however, and may be applicable over a wide range of thrust class and engine designs, including, for example, wide body engines. In some examples, the engine may include, but is not limited to, business jet propulsion engines, small turbofan engines, open rotor engines, marine and industrial turbine engines, including portable power generation units, and marine propulsion for ships.

TABLE 1

| | Power | V_{G} | V_{GB} | |
|---|---|---|---|---|
| Embodiments | (kHP) | (in\hat{ }3) | (in\hat{ }3) | LEVR |
| 1 | 20-30 | 253 | 5601 | .045 |
| 2 | 17 | 37 | 691 | .054 |

As the gearbox power, and, thus, the gearbox size/volume increases, the gutter volume also must increase to ensure proper function of the gutter. However, the relationship between LEVR and gearbox (fan) power is not linear. Furthermore, different gearbox configurations like planetary and differential could require more lubricant flow due to the lower efficiency compared to a star gearbox configuration. Therefore, these higher power gearboxes with different operating configurations could yield LEVR nearing 0.3. Accordingly, for star gearbox configurations, Table 1 shows this relationship.

Accordingly, the gutter volume is critical to minimizing the lubricant scavenge losses as the lubricant exits the gearbox and is redirected to the scavenge port of the gutter.

Therefore, the present disclosure defines a lubricant extraction volume ratio that improves or maintains gearbox efficiency, while ensuring the gutter provided with the gearbox is not oversized or undersized with respect to the needs of the gearbox. By maintaining the gutter within the range defined by the lubricant extraction volume ratio, scavenge flow collection is maximized and the negative effects of the gutter (e.g., added weight and size to the system) that may contribute to a reduction in gearbox efficiency are minimized.

Further aspects of the present disclosure are provided by the subject matter of the following clauses.

According to an aspect of the present disclosure, a gearbox assembly comprises a gearbox and a gutter. The gutter is for collecting a gearbox lubricant scavenge flow from the gearbox, the gutter being characterized by a lubricant extraction volume ratio between 0.01 and 0.3, inclusive of the endpoints.

The gearbox assembly of the preceding clause, wherein the lubricant extraction volume ratio is between 0.03 and 0.3, inclusive of the endpoints, for a gearbox power less than or equal to thirty-five kHP.

The gearbox assembly of any preceding clause, wherein the lubricant extraction volume ratio is defined by a ratio of a gutter volume of the gutter to a gearbox volume of the gearbox.

The gearbox assembly of any preceding clause, wherein the gutter volume is defined by an inner surface of a gutter wall of the gutter.

The gearbox assembly of any preceding clause, wherein the gearbox volume is defined by an outer diameter of the gearbox and a gearbox length of the gearbox.

The gearbox assembly of any preceding clause, wherein the outer diameter of the gearbox is an outer diameter of a ring gear.

The gearbox assembly of any preceding clause, wherein the gearbox length is defined between a forwardmost end of a gear of the gearbox and an aftmost end of the gear.

The gearbox assembly of any preceding clause, wherein the gearbox includes a sun gear, a plurality of planet gears, and a ring gear.

The gearbox assembly of any preceding clause, wherein the lubricant extraction volume ratio is defined by a ratio of a gutter volume of the gutter to a gearbox volume of the gearbox.

The gearbox assembly of any preceding clause, wherein the gearbox volume is defined by an outer diameter of the ring gear and a length of the gearbox.

The gearbox assembly of any preceding clause, wherein the lubricant extraction volume ratio is defined by a power factor, a flow transition time, and a heat density parameter.

The gearbox assembly of any preceding clause, wherein the flow transition time is defined by a gutter volume of the gutter and a lubricant volumetric flow rate of a lubricant through the gearbox.

The gearbox assembly of any preceding clause, wherein the flow transition time is between 1.5 seconds and eleven seconds, inclusive of the endpoints.

The gearbox assembly of any preceding clause, wherein the power factor is defined by a power density of the gearbox and an efficiency of the gearbox.

The gearbox assembly of any preceding clause, wherein the power density is between fifteen thousand hp/ft³ and forty-five thousand hp/ft³, inclusive of the endpoints, and the efficiency is between 99.2 percent and 99.8 percent, inclusive of the endpoints.

The gearbox assembly of any preceding clause, wherein the gearbox includes a sun gear, a plurality of planet gears, and a ring gear, and wherein the gutter circumscribes the ring gear.

The gearbox assembly of any preceding clause, wherein the gutter wholly circumscribes the ring gear.

The gearbox assembly of any preceding clause, wherein the gutter partially circumscribes the ring gear.

The gearbox assembly of any preceding clause, wherein the gutter is located radially outward of the gearbox.

The gearbox assembly of any preceding clause, wherein the gutter further comprises a scavenge port located near a bottom of the gutter.

The gearbox assembly of any preceding clause, wherein the gearbox is a star configuration.

The gearbox assembly of any preceding clause, wherein the gearbox is a planetary configuration.

The gearbox assembly of any preceding clause, wherein the gearbox is a differential gearbox.

The gearbox assembly of any preceding clause, wherein the gearbox volume is between eight hundred in³ and two thousand in³, inclusive of the endpoints, when the engine power is between eighteen kHP and thirty-five kHP, inclusive of the endpoints.

The gearbox assembly of any preceding clause, wherein the gutter volume is between 0.01 and 0.3 times, inclusive of the endpoints, the gearbox volume.

According to an aspect of the present disclosure, a gas turbine engine comprises a gearbox assembly comprising a gearbox and a gutter. The gutter is for collecting a gearbox lubricant scavenge flow from the gearbox, the gutter being characterized by a lubricant extraction volume ratio between 0.01 and 0.3, inclusive of the endpoints.

The gas turbine engine of any preceding clause, wherein the lubricant extraction volume ratio is between 0.01 and 0.3, inclusive of the endpoints, when the gas turbine engine has an engine power greater than or equal to thirty-five kHP.

The gas turbine engine of any preceding clause, wherein the engine power is between thirty-five kHP and ninety kHP, inclusive of the endpoints.

The gas turbine engine of any preceding clause, wherein the lubricant extraction volume ratio is between 0.03 and 0.3, inclusive of the endpoints.

The gas turbine engine of any preceding clause, wherein the lubricant extraction volume ratio is between 0.03 and 0.3, inclusive of the endpoints, when the gas turbine engine has an engine power less than or equal to thirty-five kHP.

The gas turbine engine of any preceding clause, wherein the lubricant extraction volume ratio is defined by a ratio of a gutter volume of the gutter to a gearbox volume of the gearbox.

The gas turbine engine of any preceding clause, wherein the gutter volume is defined by an inner surface of a gutter wall of the gutter.

The gas turbine engine of any preceding clause, wherein the gearbox volume is defined by an outer diameter of the gearbox and a gearbox length of the gearbox.

The gas turbine engine of any preceding clause, wherein the outer diameter of the gearbox is an outer diameter of a ring gear.

The gas turbine engine of any preceding clause, wherein the gearbox length is defined between a forwardmost end of a gear of the gearbox and an aftmost end of the gear.

The gas turbine engine of any preceding clause, wherein the gearbox includes a sun gear, a plurality of planet gears, and a ring gear.

The gas turbine engine of any preceding clause, wherein the lubricant extraction volume ratio is defined by a ratio of a gutter volume of the gutter to a gearbox volume of the gearbox.

The gas turbine engine of any preceding clause, wherein the gearbox volume is defined by an outer diameter of the ring gear and a length of the gearbox.

The gas turbine engine of any preceding clause, wherein the lubricant extraction volume ratio is defined by a power factor, a flow transition time, and a heat density parameter.

The gas turbine engine of any preceding clause, wherein the power factor is defined by a power density of the gearbox and an efficiency of the gearbox.

The gas turbine engine of any preceding clause, wherein the power density is between fifteen thousand hp/ft³ and forty-five thousand hp/ft³, inclusive of the endpoints, and the efficiency is between 99.2 percent and 99.8 percent, inclusive of the endpoints.

The gas turbine engine of any preceding clause, wherein the flow transition time is defined by a gutter volume of the gutter and a lubricant volumetric flow rate of a lubricant through the gearbox.

The gas turbine engine of any preceding clause, wherein the flow transition time is between 1.5 seconds and eleven seconds, inclusive of the endpoints.

The gas turbine engine of any preceding clause, wherein the gearbox includes a sun gear, a plurality of planet gears, and a ring gear, and wherein the gutter circumscribes the ring gear.

The gas turbine engine of any preceding clause, wherein the gutter wholly circumscribes the ring gear.

The gas turbine engine of any preceding clause, wherein the gutter partially circumscribes the ring gear.

The gas turbine engine of any preceding clause, wherein the gutter is located radially outward of the gearbox.

The gas turbine engine of any preceding clause, wherein the gutter further comprises a scavenge port located near a bottom of the gutter.

The gas turbine engine of any preceding clause, wherein the gearbox is a star configuration.

The gas turbine engine of any preceding clause, wherein the gearbox is a planetary configuration.

The gas turbine engine of any preceding clause, wherein the gearbox is a differential gearbox.

The gas turbine engine of any preceding clause, wherein the gearbox volume is between eight hundred in³ and two thousand in³, inclusive of the endpoints, when the engine power is between eighteen kHP and thirty-five kHP, inclusive of the endpoints.

The gas turbine engine of any preceding clause, wherein the gutter volume is between 0.01 and 0.3 times, inclusive of the endpoints, the gearbox volume.

A gas turbine engine including a fan, a compressor section, a turbine section that includes a rotating shaft, and a combustion section in flow communication with the compressor section and the turbine section, an engine static structure; an electric power system including at least one electric machine drivingly coupled to the rotating shaft and generating electricity as a first type of current, a plurality of power converters electrically coupled with the at least one electric machine, the plurality of power converters converting the electricity as the first type of current from the at least one electric machine to a second type of current, and a plurality of power distribution management units electrically coupled with the plurality of power converters, the plurality of power distribution management units supplying the electricity as the second type of current to at least one of the gas turbine engine or one or more aircraft systems of an aircraft, wherein at least two of the plurality of power converters or the plurality of power distribution management units are integrated together in a single housing, and a gearbox assembly including a gearbox having a gearbox volume defined by an outer diameter of the gearbox and a gearbox length of the gearbox, and a gutter for collecting a gearbox lubricant scavenge flow from the gearbox, the gutter having a gutter volume defined by an inner surface of a gutter wall of the gutter and being characterized by a lubricant extraction volume ratio between 0.01 and 0.3, inclusive of the endpoints, the lubricant extraction volume ratio defined by V_{G}/V_{GB}, wherein V_{G} is the gutter volume of the gutter and V_{GB} is the gearbox volume.

The gas turbine engine of the preceding clause, wherein at least one of the plurality of power converters is integrated together with the at least one electric machine in a power converter housing.

The gas turbine engine of any preceding clause, wherein the plurality of power converters includes a plurality of low-pressure power converters thermally coupled together by a first power converter cold plate that cools the plurality of low-pressure power converters.

The gas turbine engine of any preceding clause, wherein the plurality of power converters includes a plurality of high-pressure power converters thermally coupled together by a second power converter cold plate that cools the plurality of high-pressure power converters.

The gas turbine engine of any preceding clause, wherein the rotating shaft is a low-pressure shaft, the turbine section includes a high-pressure shaft, and the at least one electric machine includes a low-pressure electric machine drivingly coupled to the low-pressure shaft and a high-pressure electric machine drivingly coupled to the high-pressure shaft.

The gas turbine engine of any preceding clause, wherein the plurality of power converters includes a plurality of low-pressure power converters integrated together with the low-pressure electric machine in a low-pressure power converter housing.

The gas turbine engine of any preceding clause, wherein the plurality of power converters includes a plurality of high-pressure power converters integrated together with the high-pressure electric machine in a high-pressure power converter housing.

The gas turbine engine of any preceding clause, wherein the plurality of power distribution management units includes a first power distribution management unit and a second power distribution management unit that are integrated together in a power distribution management unit housing.

The gas turbine engine of any preceding clause, wherein the first power distribution management unit is thermally coupled with the second power distribution management unit via a power distribution management unit cold plate that cools the first power distribution management unit and the second power distribution management unit.

The gas turbine engine of any preceding clause, wherein at least one of the plurality of power converters is integrated together with the plurality of power distribution management units in the power distribution management unit housing.

The gas turbine engine of any preceding clause, wherein the plurality of power converters includes a first low-pressure power converter and a first high-pressure power converter thermally coupled together by a first power converter cold plate.

The gas turbine engine of any preceding clause, wherein the plurality of power converters includes a second low-pressure power converter and a second high-pressure power converter thermally coupled together by a second power converter cold plate.

A gas turbine engine including a fan, a compressor section, a turbine section that includes a low-pressure shaft and a high-pressure shaft, and a combustion section in flow communication with the compressor section and the turbine section, an engine static structure, an electric power system including a low-pressure electric machine drivingly coupled to the low-pressure shaft and generating electricity as a first type of current, a high-pressure electric machine drivingly coupled to the high-pressure shaft and generating electricity as the first type of current, a plurality of low-pressure power converters electrically coupled with the low-pressure electric machine, the plurality of low-pressure power converters converting the electricity as the first type of current from the low-pressure electric machine to a second type of current, a plurality of high-pressure power converters electrically coupled with the high-pressure electric machine, the plurality of high-pressure power converters converting the electricity as the first type of current from the high-pressure electric machine to the second type of current, and a plurality of power distribution management units electrically coupled with the plurality of low-pressure power converters and the plurality of high-pressure power converters, the plurality of power distribution management units supplying the electricity as the second type of current to at least one of the gas turbine engine or one or more aircraft systems of an aircraft, wherein the plurality of power distribution management units includes a first power distribution management unit and a second power distribution management unit that are integrated together in a power distribution management unit housing, and a gearbox assembly including a gearbox having a gearbox volume defined by an outer diameter of the gearbox and a gearbox length of the gearbox, and a gutter for collecting a gearbox lubricant scavenge flow from the gearbox, the gutter having a gutter volume defined by an inner surface of a gutter wall of the gutter and being characterized by a lubricant extraction volume ratio between 0.01 and 0.3, inclusive of the endpoints, the lubricant extraction volume ratio defined by V_{G}/V_{GB}, wherein V_{G} is the gutter volume of the gutter and V_{GB} is the gearbox volume.

The gas turbine engine of any preceding clause, wherein at least one of the plurality of low-pressure power converters is integrated together with the low-pressure electric machine or the plurality of high-pressure power converters is integrated together with the high-pressure electric machine.

The gas turbine engine of any preceding clause, wherein the plurality of low-pressure power converters is thermally coupled together by a first power converter cold plate that cools the plurality of low-pressure power converters.

The gas turbine engine of any preceding clause, wherein the plurality of high-pressure power converters is thermally coupled together by a second power converter cold plate that cools the plurality of high-pressure power converters.

The gas turbine engine of any preceding clause, wherein the plurality of low-pressure power converters is integrated together in a low-pressure power converter housing.

The gas turbine engine of any preceding clause, wherein the plurality of high-pressure power converters is integrated together in a high-pressure power converter housing.

The gas turbine engine of any preceding clause, wherein the first power distribution management unit is thermally coupled with the second power distribution management unit via a power distribution management unit cold plate that cools the first power distribution management unit and the second power distribution management unit.

The gas turbine engine of any preceding clause, wherein at least one of the plurality of low-pressure power converters or the plurality of high-pressure power converters is integrated together with the plurality of power distribution management units in the power distribution management unit housing.

Although the foregoing description is directed to the preferred embodiments, other variations and modifications will be apparent to those skilled in the art, and may be made without departing from the disclosure. Moreover, features described in connection with one embodiment may be used in conjunction with other embodiments, even if not explicitly stated above.

1. A gas turbine engine comprising:
a fan, a compressor section, a turbine section that includes a rotating shaft, and a combustion section in flow communication with the compressor section and the turbine section;
an engine static structure;
an electric power system comprising:
at least one electric machine drivingly coupled to the rotating shaft and generating electricity as a first type of current;
a plurality of power converters electrically coupled with the at least one electric machine, the plurality of power converters converting the electricity as the first type of current from the at least one electric machine to a second type of current; and
a plurality of power distribution management units electrically coupled with the plurality of power converters, the plurality of power distribution management units supplying the electricity as the second type of current to at least one of the gas turbine engine or one or more aircraft systems of an aircraft, wherein at least two of the plurality of power converters or the plurality of power distribution management units are integrated together in a single housing; and
a gearbox assembly comprising:
a gearbox having a gearbox volume defined by an outer diameter of the gearbox and a gearbox length of the gearbox; and
a gutter for collecting a gearbox lubricant scavenge flow from the gearbox, the gutter having a gutter volume defined by an inner surface of a gutter wall of the gutter and being characterized by a lubricant extraction volume ratio between 0.01 and 0.3, inclusive of the endpoints, the lubricant extraction volume ratio defined by:
V_{G}/V_{GB},
wherein V_{G} is the gutter volume of the gutter and V_{GB} is the gearbox volume.

2. The gas turbine engine of claim 1, wherein at least one of the plurality of power converters is integrated together with the at least one electric machine in a power converter housing.

3. The gas turbine engine of claim 1, wherein the plurality of power converters includes a plurality of low-pressure power converters thermally coupled together by a first power converter cold plate that cools the plurality of low-pressure power converters.

4. The gas turbine engine of claim 3, wherein the plurality of power converters includes a plurality of high-pressure power converters thermally coupled together by a second power converter cold plate that cools the plurality of high-pressure power converters.

5. The gas turbine engine of claim 1, wherein the rotating shaft is a low-pressure shaft, the turbine section includes a high-pressure shaft, and the at least one electric machine includes a low-pressure electric machine drivingly coupled to the low-pressure shaft and a high-pressure electric machine drivingly coupled to the high-pressure shaft.

6. The gas turbine engine of claim 5, wherein the plurality of power converters includes a plurality of low-pressure power converters integrated together with the low-pressure electric machine in a low-pressure power converter housing.

7. The gas turbine engine of claim 5, wherein the plurality of power converters includes a plurality of high-pressure power converters integrated together with the high-pressure electric machine in a high-pressure power converter housing.

8. The gas turbine engine of claim 1, wherein the plurality of power distribution management units includes a first power distribution management unit and a second power distribution management unit that are integrated together in a power distribution management unit housing.

9. The gas turbine engine of claim 8, wherein the first power distribution management unit is thermally coupled with the second power distribution management unit via a power distribution management unit cold plate that cools the first power distribution management unit and the second power distribution management unit.

10. The gas turbine engine of claim 8, wherein at least one of the plurality of power converters is integrated together with the plurality of power distribution management units in the power distribution management unit housing.

11. The gas turbine engine of claim 10, wherein the plurality of power converters includes a first low-pressure power converter and a first high-pressure power converter thermally coupled together by a first power converter cold plate.

12. The gas turbine engine of claim 11, wherein the plurality of power converters includes a second low-pressure power converter and a second high-pressure power converter thermally coupled together by a second power converter cold plate.

13. A gas turbine engine comprising:
a fan, a compressor section, a turbine section that includes a low-pressure shaft and a high-pressure shaft, and a combustion section in flow communication with the compressor section and the turbine section;
an engine static structure;
an electric power system comprising:
a low-pressure electric machine drivingly coupled to the low-pressure shaft and generating electricity as a first type of current;
a high-pressure electric machine drivingly coupled to the high-pressure shaft and generating electricity as the first type of current;
a plurality of low-pressure power converters electrically coupled with the low-pressure electric machine, the plurality of low-pressure power converters converting the electricity as the first type of current from the low-pressure electric machine to a second type of current;
a plurality of high-pressure power converters electrically coupled with the high-pressure electric machine, the plurality of high-pressure power converters converting the electricity as the first type of current from the high-pressure electric machine to the second type of current; and
a plurality of power distribution management units electrically coupled with the plurality of low-pressure power converters and the plurality of high-pressure power converters, the plurality of power distribution management units supplying the electricity as the second type of current to at least one of the gas turbine engine or one or more aircraft systems of an aircraft, wherein the plurality of power distribution management units includes a first power distribution management unit and a second power distribution management unit that are integrated together in a power distribution management unit housing; and
a gearbox assembly comprising:
a gearbox having a gearbox volume defined by an outer diameter of the gearbox and a gearbox length of the gearbox; and
a gutter for collecting a gearbox lubricant scavenge flow from the gearbox, the gutter having a gutter volume defined by an inner surface of a gutter wall of the gutter and being characterized by a lubricant extraction volume ratio between 0.01 and 0.3, inclusive of the endpoints, the lubricant extraction volume ratio defined by:
V_{G}/V_{GB},
wherein V_{G} is the gutter volume of the gutter and V_{GB} is the gearbox volume.

14. The gas turbine engine of claim 13, wherein at least one of the plurality of low-pressure power converters is integrated together with the low-pressure electric machine or the plurality of high-pressure power converters is integrated together with the high-pressure electric machine.

15. The gas turbine engine of claim 13, wherein the plurality of low-pressure power converters is thermally coupled together by a first power converter cold plate that cools the plurality of low-pressure power converters.

16. The gas turbine engine of claim 13, wherein the plurality of high-pressure power converters is thermally coupled together by a second power converter cold plate that cools the plurality of high-pressure power converters.

17. The gas turbine engine of claim 13, wherein the plurality of low-pressure power converters is integrated together in a low-pressure power converter housing.

18. The gas turbine engine of claim 13, wherein the plurality of high-pressure power converters is integrated together in a high-pressure power converter housing.

19. The gas turbine engine of claim 13, wherein the first power distribution management unit is thermally coupled with the second power distribution management unit via a power distribution management unit cold plate that cools the first power distribution management unit and the second power distribution management unit.

20. The gas turbine engine of claim 13, wherein at least one of the plurality of low-pressure power converters or the plurality of high-pressure power converters is integrated together with the plurality of power distribution management units in the power distribution management unit housing.
